(19) United States
(12) Patent Application Publication
(10) Pub. No.: US 2004/0251843 A1
(43) Pub. Date: Dec. 16, 2004

(54) Electric lamp and method of manufacturing the same, and image display device employing the same

(76) Inventors: Seock-Hwan Kang, Suwan-si (KR); Hyeong-Suk Yoo, Yongin-si (KR); Se-Jin Park, Yongin-si (KR)

Correspondence Address: Cantor Colburn LLP, 55 Griffin South Road, Bloomfield, CT, 06002, US

(21) Appl. No.: 10/773,908

(22) Filed: Feb. 5, 2004

(30) Foreign Application Priority Data
Jun. 11, 2003 (KR) 2003-37554

(51) Int. Cl. G09G 3/10

(52) U.S. Cl. 315/169.3

(57) ABSTRACT

A lamp includes a lamp body in which a discharge gas is injected, and first and second electrodes disposed at opposite ends of the lamp body. The first electrode includes a first member that receives a first end portion of the lamp body and a second member that is disposed between the first member and the lamp body. The second electrode includes a third member that receives a second end portion of the lamp body and a fourth member disposed between the third member and the lamp body. The second and fourth members each have metallic solder. A rough surface is formed on each of the first and second end portions of the lamp body. A backlight assembly employs the lamp, and a liquid crystal display device employs the backlight assembly.

### BACKGROUND OF THE INVENTION

1. Field of the Invention

The present invention relates to an electric lamp generating light, and more particularly to a lamp having enhanced luminance, lower power consumption and longer lifespan and a method of manufacturing the same and also to an image display device employing the lamp.

2. Description of the Related Art

One of the lamp types that have been used for image display devices is a cold cathode fluorescent lamp (CCFL). Generally, a CCFL has a lamp body containing discharge gas therein and a pair of electrodes formed within the lamp body. A driving voltage with a sufficient voltage difference is applied between the inner electrodes of the lamp. As a result, the lamp emits light due to an electric discharge occurred in the lamp body.

The lamp body includes a fluorescent layer as well as the discharge gas. The fluorescent layer is formed on inner surface of the lamp body. The inner electrodes are installed at the opposite ends of the lamp body to face each other. Each of the inner electrodes includes an electrode body and a lead wire that are electrically connected to each other. The electrode body is disposed in the lamp body, and the lead wire connected to the electrode body is partially protruded from the lamp body. Thus, the driving voltage is applied to the electrodes of the lamp through the lead wires of which the protrusions are exposed.

The CCFL type lamps generate white light and are widely used for a light source of image display devices, such as a liquid crystal display device, as well as for house and office lighting. Since most image display devices are sensitive to heat, the CCFL type lamps have been in demand for the image display devices owing to its relatively lower heat generation.

However, the conventional CCFL type lamps have problems such as non-uniform characteristics in their light radiation. In other words, in case that multiple CCFL type lamps each having the inner electrodes are arranged to constitute a light source for a display device, the lamps each have different radiation characteristics so that each lamp generates light with luminance different from those of other lamps. As a result, the display device displays variegated images.

To prevent such problems, a separate power source is provided for each lamp so that the multiple lamps have uniform radiation characteristics by controlling each output of the respective power sources. In this case, however, there is inevitably a substantial increase in weight and volume of a light assembly for providing the light and in the cost for manufacturing the same.

Therefore, a need exists for a lamp which has a relatively longer lifespan and lower power consumption while the multiple lamps driven by a single power source have substantially uniform radiation characteristics. It will be also advantageous to provide a method of manufacturing such a lamp with no increase in the manufacturing cost. It is also further desirable to provide a light assembly employing a multiple number of such lamps and a display device including the light assembly with the lamps.

### SUMMARY OF THE INVENTION

The above-discussed and other drawbacks and deficiencies of the prior art are overcome or alleviated by the lamp and the method of manufacturing the same according to the present invention.

In one embodiment, there is provided a lamp for emitting light including a lamp body in which a discharge gas is injected, and first and second electrodes disposed at opposite ends of the lamp body, for receiving current externally provided. The first electrode includes a first member that receives a first end portion of the lamp body and is electrically conductive, and a second member that is disposed between the first member and the lamp body and has metallic solder and is coated on the first end portion of the lamp body to provide adhesion between the first member and the lamp body. The first end portion of the lamp body may have a rough surface on which the second member of the first electrode is coated. The rough surface increases adhesion between the first end portion of the lamp body and the second member of the first electrode.

In another embodiment, the second electrode of the lamp also includes a third member that receives a second end portion of the lamp body and is electrically conductive, and a fourth member disposed between the third member and the lamp body. The fourth member may have metallic solder and be coated on the second end portion of the lamp body to provide adhesion between the third member and the lamp body. The second end portion of the lamp body has a rough surface on which the fourth member of the second electrode is coated. The rough surface increases adhesion between the second end portion of the lamp body and the fourth member of the second electrode.

In another embodiment, the second electrode may include a third member that is disposed in the second end portion of the lamp body and receives a driving voltage externally provided, and a fourth member for receiving the second end portion of the lamp body in which the third member is disposed. The fourth member has a contact part through which the third member is in contact with an electric source providing the driving voltage. The third member of the second electrode may include an electrode body disposed in the discharge gas of the lamp body, a lead wire for transferring the driving voltage to the electrode body, and a sealing member for sealing the second end portion of the lamp body to prevent a leak of the discharge gas and for holding the lead wire. The sealing member has a conduit through which the lead wire is extended from the electrode body to the fourth member. The contact part of the fourth member may be a hole through which the lead wire is extended to be in contact with the electric source and at which the lead wire is soldered.

In another embodiment, there is provided a light assembly for providing light, including one of the lamps described above, a voltage applying module for receiving a driving voltage from an external source and providing the driving voltage to the first and second electrodes of the lamp, and a receiving container for receiving and securely holing the lamp and the voltage applying module. The receiving container may include a first frame for receiving the first electrode of the lamp and a first lamp clip for holding the first electrode of the lamp. The first frame also includes upper and lower parts between which the first electrode of the lamp is disposed and a connection part connected with the upper and lower parts. The connection part having an opening through which the first electrode of the lamp is inserted.

In another embodiment, there is provide an image display device for displaying images using light internally provided, including a display panel for displaying images using the light and image data externally provided, the above mentioned light assembly for providing the light, a first holding memberdisposed between the display panel and the light assembly, the first holding member securely holding the display panel onto the light assembly, and a second holding member connected to the receiving container, the second holding member securely holding an edge of the display panel to prevent the display panel and the light assembly from being disassembled.

There is also provided a method of manufacturing a lamp, including the steps of forming a fluorescent layer on an inner surface of a lamp body, inserting a discharge gas in the lamp body, coating a first end portion of the lamp body with conductive material to form a first conductive layer on the first end portion, in which the conductive material has metallic solder, and combining the lamp body with a first metal tube by inserting the first end portion into the first metal tube to form a first electrode of the lamp. The method may further include forming a first rough surface on the first end portion of the lamp body to increase adhesion between the first end portion and the first conductive layer coated on the first end portion and heating the first electrode to melt the conductive material so that the first conductive layer is uniformly filled with a uniform thickness between the first metal tube and the first end portion of the lamp body. The method may further include coating the second end portion of the lamp body with the conductive material to form a second conductive layer on the second end portion, combining the lamp body with a second metal tube by inserting the second end portion into the second metal tube to form a second electrode of the lamp, forming a second rough surface on the second end portion of the lamp body to increase adhesion between the second end portion and the second conductive layer coated on the second end portion, and heating the second electrode to melt the conductive material so that the second conductive layer is uniformly filled with a uniform thickness between the second metal tube and the second end portion of the lamp body.

These and other objects, features and advantages of the present invention will become apparent from the following detailed description of illustrative embodiments thereof, which is to be read in connection with the accompanying drawings.

### BRIEF DESCRIPTION OF THE DRAWINGS

This disclosure will present in detail the following description of exemplary embodiments with reference to the following figures wherein:

FIG. 1 is a perspective view illustrating a part of a lamp according to an exemplary embodiment of the present invention;

FIG. 2 is a cross-sectional view of the lamp taken along line A-A′ in FIG. 1;

FIG. 3 is a cross-sectional view of the lamp taken along line B-B′ in FIG. 1;

FIG. 4 is a plan view of an electrode connection portion of the lamp in FIG. 1;

FIG. 5 is a cross-sectional view of a lamp according to another exemplary embodiment of the present invention;

FIG. 6 is a perspective view illustrating a lamp according to another exemplary embodiment of the present invention;

FIG. 7 is a cross-sectional view of the lamp taken along line C-C′ in FIG. 6;

FIG. 8 is a cross-sectional view of the lamp taken along line D-D′ in FIG. 6,

FIG. 9 is a plan view of an electrode connection portion of the lamp in FIG. 6;

FIG. 10 is a cross-sectional view of a lamp according to another exemplary embodiment of the present invention;

FIG. 11 is a partially exploded, perspective view of a lamp according to another exemplary embodiment of the present invention;

FIG. 12 is a cross-sectional view of the lamp taken along line E-E′ in FIG. 11;

FIGS. 13A to 13D are schematic views for describing a process of manufacturing the lamp in FIG. 1 according to an embodiment of the present invention;

FIGS. 14A to 14E are schematic views for describing a process of manufacturing the lamp in FIG. 6 according to an embodiment of the present invention;

FIGS. 15A to 15D are schematic views for describing a process of manufacturing the lamp in FIG. 11 according to an embodiment of the present invention;

FIG. 16 is a cross-sectional view of a backlight assembly according to an embodiment of the present invention;

FIG. 17 is a schematic diagram illustrating configuration of the backlight assembly in FIG. 16 according to an embodiment of the present invention;

FIG. 18 is a schematic diagram illustrating configuration of the backlight assembly in FIG. 16 according to another embodiment of the present invention;

FIG. 19 is a schematic diagram illustrating configuration of the backlight assembly in FIG. 16 according to another embodiment of the present invention;

FIG. 20 is a cross-sectional view of a backlight assembly according to another embodiment of the present invention;

FIG. 21 is a schematic diagram illustrating configuration of the backlight assembly in FIG. 20 according to an embodiment of the present invention;

FIG. 22 is a schematic diagram illustrating configuration of the backlight assembly in FIG. 20 according to another embodiment of the present invention;

FIG. 23 is a schematic diagram illustrating configuration of the backlight assembly in FIG. 20 according to another embodiment of the present invention;

FIG. 24 is a cross-sectional view of a backlight assembly according to another embodiment of the present invention;

FIG. 25 is a schematic diagram illustrating configuration of the backlight assembly in FIG. 24 according to an embodiment of the present invention;

FIG. 26 is a schematic diagram illustrating configuration of the backlight assembly in FIG. 24 according to another embodiment of the present invention;

FIG. 27 is a schematic diagram illustrating configuration of the backlight assembly in FIG. 24 according to another embodiment of the present invention; and

FIG. 28 is a cross-sectional view illustrating a liquid crystal display device according to an exemplary embodiment of the present invention.

### DETAILED DESCRIPTION OF THE INVENTION

Detailed illustrative embodiments of the present invention are disclosed herein. However, specific structural and functional details disclosed herein are merely representative for purposes of describing exemplary embodiments of the present invention.

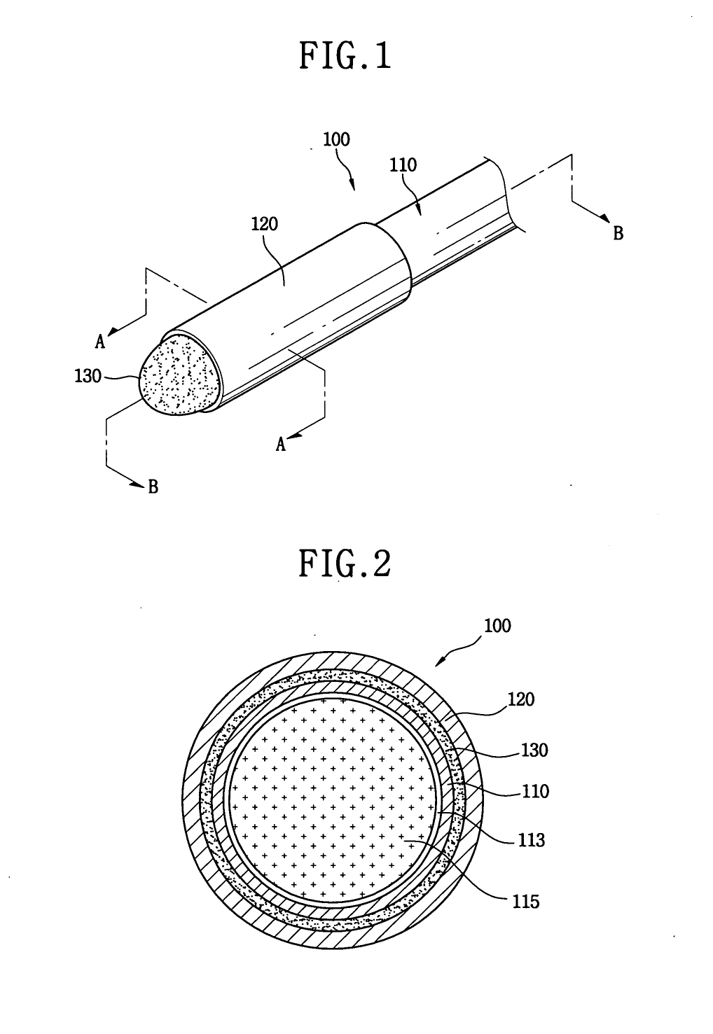

Referring to FIG. 1, a perspective diagram is provided for illustrating a lamp according to an exemplary embodiment of the present invention. The lamp 100 in FIG. 1 includes a lamp body 110 and first and second electrodes. The first electrode includes a first electrode member 120 and a second electrode member 130 that are formed at one end of the lamp body 110.

The lamp body 110 has a tube shape of which ends are sealed. The tube shape lamp body 110 may have different shapes or bends such as straight, L-shape, U-shape, etc. At the opposite ends of the lamp body 110, the first and second electrodes are formed, respectively. One of the electrodes is shown in FIG. 1.

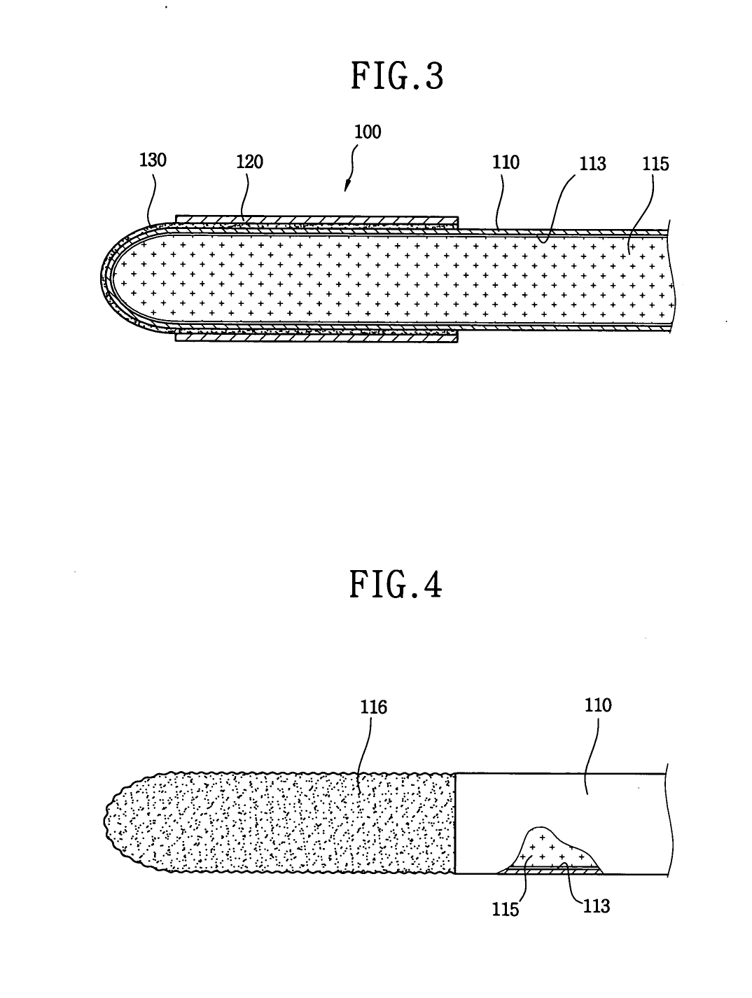

FIG. 2 is a cross-sectional view of the lamp taken along line A-A′ in FIG. 1, and FIG. 3 is a cross-sectional view of the lamp taken along line B-B′ in FIG. 1. Referring to FIGS. 2 and 3, a lamp body 110 includes a fluorescent layer 113 and a discharge gas 115. The fluorescent layer 113 is coated on the inner surface of the lamp body 110. The fluorescent layer 113 transforms an invisible ray such as ultraviolet ray into a visible ray. The fluorescent layer 113 includes red fluorescent material, green fluorescent material and blue fluorescent material in the form of a mixture. The red, green and blue fluorescent material emits red, green and blue light, respectively. In the lamp body 110, the red, green and blue fluorescent material each have a substantially identical amount, and thus the lamp 100 emits white light through the fluorescent layer.

The discharge gas 115 is injected into the lamp body 110 so that the lamp body 110 has a predetermined internal pressure. The discharge gas 115 is ionized by being discharged in the form of plasma. For example, the discharge gas 115 includes mercury (Hg) and may further include a small amount of Argon (Ar), Neon (Ne), Xenon (Xe), Krypton (Kr) or a mixture thereof.

As mentioned above, the first electrode member 120 has a tube shape with the open ends. The end portion of the lamp body 110 is inserted into the first electrode member 120 through the open ends. Instead of the tube-shaped electrode member 120, an electrode member may be formed at the end portion of the lamp body 110 by a hot dipping process or a plating process. In this case, the electrode member has a thickness of about 511 m. When a high voltage, from a few of kV to a few tens of kV, is repeatedly applied to the thin electrode member of an electrode, the electrode member is readily subject to a damage due to a corona discharge that gives impact on the electrode member. As a result, the electrode member is partially removed from the lamp body 110, so that the areal size of the electrode member decreases. This causes a decrease in heat dissipation through the electrode member and, thus, an increase in temperature and driving voltage of the lamp. Thus, a light assembly employing such a lamp has a higher power consumption.

In contrast, the lamp 100 of this embodiment employs the first electrode member 120 having a thickness enough not to be removed from the lamp body 110. For example, the first electrode member 120 has a thickness in the range from about 0.1 mm to about 0.2 mm. The first electrode member 120 is made of material including nickel (Ni) or nickel alloy. Also, the first electrode member 120 may be a brass tube or a brass tube with gold coating.

The second electrode member 130 is formed on the outer surface of the lamp body 110 and beneath the first electrode member 120. The second electrode member 130 is formed between the lamp body 110 and the first electrode member 120 by being melted and coated on the surface of the end portion of the lamp body 110. Such formation of the second electrode member 130 prevents a gap between the lamp body 110 and the first electrode member 120 and also prevents the first electrode member 120 from being detached from the lamp body 110. If there is a gap between the lamp body 110 and the first electrode member 120, a voltage signal applying to the first electrode member 120 is not transferred to the lamp body 110 and the first electrode member 120 may be separated from the lamp body 110. In this embodiment, the second electrode member 130 is made of material having a melting point effectively lower than that of the material of the first electrode member 120. For example, the material of the second electrode member 130 includes lead (Pb). By employing the second electrode member 130 and such formation method, the first electrode member 120 is not separated from the lamp body 110 even when the lamp 100 is used for a prolonged time period.

The second electrode member 130 is also made of material having thermoset plastic with silver (Ag) beads. By disposing such second electrode member between the lamp body and the first electrode member, the thermoset plastic provides adhesion between the lamp body and the first electrode member, and the silver beads provides electrical connection between the lamp body and the first electrode member. However, when the thermoset plastic is repeatedly subjected to a thermal impact, it becomes fragile and its polymer becomes hardened so as to be easily broken. As a result, a gap is formed and increased between the lamp body and first electrode member so that the first electrode member is detached from the lamp body.

In contrast, since the second electrode member 130 in this embodiment is melted and coated on the lamp body 110, the second electrode member 130 is not hardened or broken by the thermal impact so that the first electrode member 120 is not detached from the lamp body and there is no decrease in the luminance of the lamp 100. For example, the second electrode member 130 is made of material including electrically conductive nonferrous metal, alloyed nonferrous metal or alloyed metal, of which melting point is lower than that of the first electrode member 120. In particular, the material of the second electrode member 130 may include leadless metal (Pb free metal) mixed with tin (Sn) and zinc (Zn), lead mixed with silver (Ag), lead, alloyed lead, or a mixture thereof.

FIG. 4 is a plan view illustrating an electrode connection portion formed at the first electrode of the lamp in FIG. 1. Referring to FIGS. 3 and 4, the electrode connecting portion 116 is formed at an end portion of the lamp body 110 to increase the adhesive force between the second electrode member 130 and the lamp body 110. The electrode connecting portion 116 of the lamp body 110 has a rough surface to increase the surface area and its roughness, which is in contact with the second electrode member 130. For example, the end portion of the lamp body 110 is dipped into chemicals such as hydrogen fluoride and hydrofluoric acid to form the electrode connecting portion 116. In another way, small particles such as sands collide against the end portion of the lamp body 110 to form the electrode connecting portion 116. Other chemical or mechanical methods may be used to form the electrode connecting portion 116.

In this embodiment, the lamp has the two electrodes (i.e., the lamp body has the two end portions). The first and second electrode members 120 and 130 are formed at one of the two electrodes, and any type of electrode may be formed at the other end.

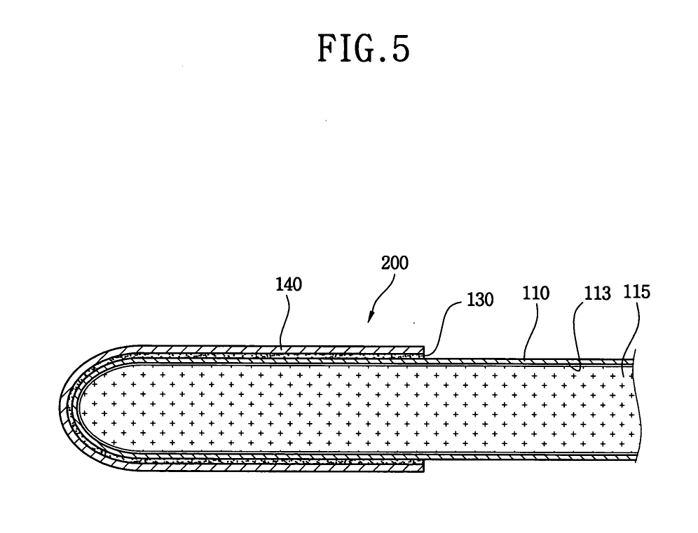

FIG. 5 is a cross-sectional view of a lamp according to another exemplary embodiment of the present invention. In FIG. 5, the same parts as those shown in FIG. 3 are represented with like reference numerals and to avoid description duplication, accordingly, their explanation will be omitted. In this embodiment, the lamp 200 includes a first electrode member 140 having a tube shape which receives the lamp body 110. The first electrode member 140 has one end opened and the other end closed. Since the first electrode member 140 has the closed end, the surface area of the first electrode member 140 in FIG. 5 is larger than that of the first electrode member 120 in FIG. 3. As the surface area of the first electrode member 140 is larger, the driving voltage for emitting electrons at the electrode may be lowered. Thus, the power consumption of the lamp is decreased.

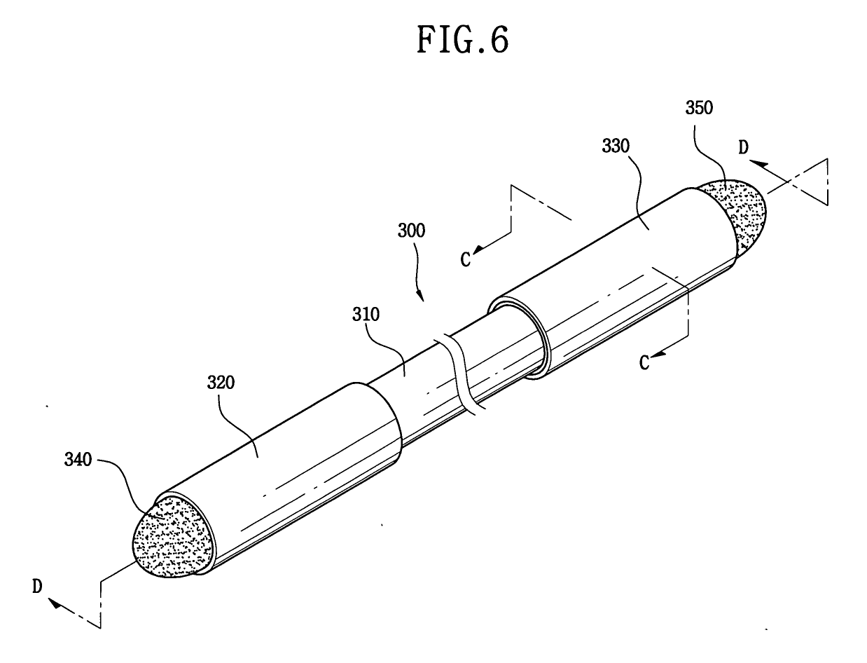

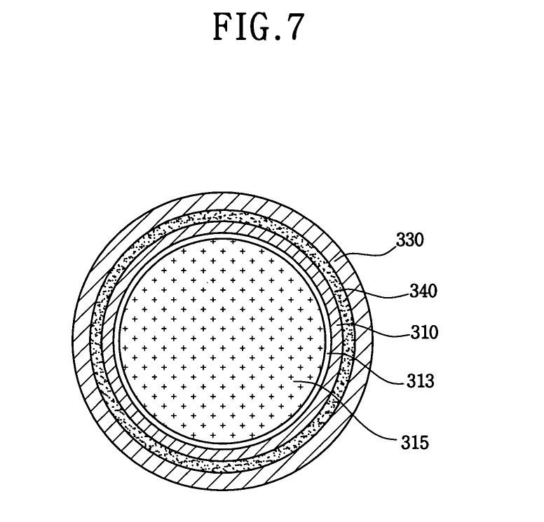

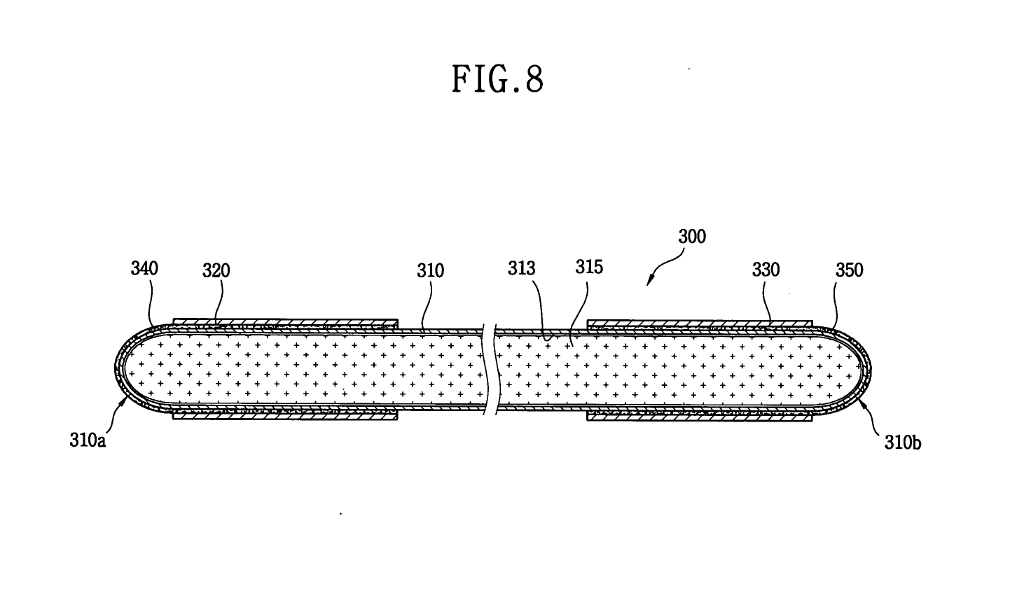

FIG. 6 is a perspective view illustrating a lamp according to another exemplary embodiment of the present invention. FIG. 7 is a cross-sectional view of the lamp taken along line C-C′ in FIG. 6, and FIG. 8 is a cross-sectional view of the lamp taken along line

D-D′ in FIG. 6. Referring to FIGS. 6 to 8, the lamp 300 includes a lamp body 310, a first electrode having first and second members 320, 340, and a second electrode having third and fourth members 330, 350.

The lamp body 310 has a closed tube shape which is, for example, straight, L-shaped or U-shaped. At the first and second end portions 310a, 310b of the lamp body 310, the first and second electrodes are formed respectively. The lamp body 310 includes a fluorescent layer 313 and a discharge gas 315. The fluorescent layer 313 is formed on the inner surface of the lamp body 310 and the discharge gas 315 is injected therein.

The fluorescent layer 313 transforms an invisible ray such as ultraviolet ray into a visible ray. The fluorescent layer includes red fluorescent material, green fluorescent material and blue fluorescent material in the form of a mixture. The red, green and blue fluorescent material emits red, green and blue light, respectively. An amount of each of the red, green and blue fluorescent material is substantially identical, and, thus, lamp 300 emits white light through the fluorescent layer 313.

The discharge gas 315 is injected into the lamp body 310, such that the lamp body 310 has a predetermined inner pressure. The discharge gas 315 is ionized by being discharged in the form of plasma. The discharge gas 315 includes, for example, a small amount of Argon (Ar), Neon (Ne), Xenon (Xe), Krypton (Kr) or a mixture thereof, and may further include mercury (Hg).

The first electrode of the lamp 300 has the first and second members 320, 340 disposed at the first end portion 310a of the lamp body 310, and the second electrode of the lamp 300 has the third and fourth members 330, 350 disposed at the second end portion 310b of the lamp body 310. The first and third members 320, 330 each have a tube shape with the open ends, so that the first and second end portions 310a, 310b of the lamp body 310 are inserted into the first and third members 320, 330, respectively.

In this embodiment, the first and third members 320, 330 each have a thickness enough not to be removed from the lamp body 110. For example, the first and third members 320, 330 each have a thickness in the range from about 0.1 mm to about 0.2 mm. The first and third members 320, 330 are made of material including nickel (Ni) or nickel alloy. Also, the first and third members 320, 330 each may be a brass tube or a brass tube with gold coating.

If a gap is formed between the first or third member and the lamp body 310, a driving voltage applied to the first or third member is not transferred to the lamp body 310. Also, the first or third member may be easily removed from the lamp body 310. To prevent such a gap and removal, the second and fourth members 340, 350 are formed at the first and second electrodes, respectively, of the lamp 300.

The second member 340 is formed on the surface of the first end portion 310a of the lamp body 310. The second member 340 is interposed between the lamp body 310 and the first member 320. The second member 340 is melted and coated on the lamp body 310 so that the first member 320 is prevented from being detached from the lamp body 310.

The fourth member 350 is formed on the surface of the second end portion 310b of the lamp body 310. The fourth member 350 is interposed between the lamp body 310 and the third member 330. The fourth member 350 is also melted and coated on the lamp body 310 so that the third member 330 is prevented from being detached from the lamp body 310. In this embodiment, the second and fourth members 340, 350 are each made of material having a melting point effectively lower than that of the material of the first and third members 320, 330. For example, the material of the second and fourth members 340, 350 includes lead (Pb). By employing the second and fourth members 340, 350 and such formation method, the first and third members 320, 330 are not separated from the lamp body 310 even when the lamp 300 is used for a prolonged time period. Also, there is no decrease in the luminance of the lamp 300.

The second and fourth members 340, 350 of the first and second electrodes may be made of material having thermoset plastic with silver (Ag) beads. By disposing such second and fourth members 340, 350 between the lamp body and the first and third members 320, 330, respectively, the thermoset plastic provides adhesion between the lamp body and the first and third members, and the silver beads provide electrical connection between the lamp body and the first and third members. However, when the thermoset plastic is repeatedly subjected to a thermal impact, it becomes fragile and its polymer becomes hardened so as to be easily broken. As a result, a gap is formed and increased between the lamp body and first and third members so that the first and third members are detached from the lamp body.

In contrast, since the second and fourth members 340, 350 in this embodiment are melted and coated on the lamp body 310, the second and fourth members 340, 350 are not hardened or broken by the thermal impact so that the first and third members 320, 330 are not detached from the lamp body and there is no decrease in the luminance of the lamp 300. For example, the second and fourth members 340, 350 are made of material including electrically conductive nonferrous metal, alloyed nonferrous metal or alloyed metal, of which melting point is lower than that of the first and third members 320, 330. In particular, the material of the second and fourth members 340, 350 may include leadless metal (Pb free metal) mixed with tin (Sn) and zinc (Zn), lead mixed with silver (Ag), lead, alloyed lead, or a mixture thereof.

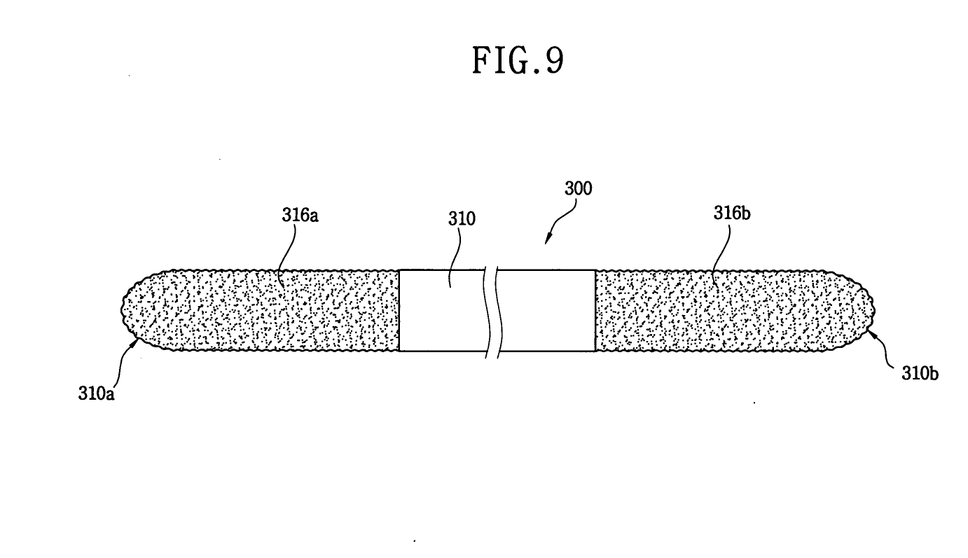

FIG. 9 is a plan view illustrating electrode connection portions formed at the first and second electrodes of the lamp in FIG. 6. Referring to FIGS. 8 and 9, a first electrode connecting portion 316a is formed at the first end portion 310a of the lamp body 310 to increase the adhesive force between the second member 340 and the lamp body 310. A second electrode connecting portion 316b is formed at the second end portion 310b of the lamp body 310 to increase the adhesive force between the fourth member 350 and the lamp body 310. The first and second electrode connecting portions of the lamp body 310 each have a rough surface to increase the surface area and its roughness. As a result, the adhesion between the lamp body 310 and the second and fourth members is increased.

For example, the first and second end portions 310a, 310b of the lamp body are dipped into chemicals such as hydrogen fluoride and hydrofluoric acid to form the first and second electrode connecting portions 316a, 316b. In another way, small particles such as sands collide against the first and second end portions 310a, 310b of the lamp body 310 to form the first and second electrode connecting portions 316a, 316b. Other chemical or mechanical methods may be used to form the first and second electrode connecting portions 316a, 316b.

In this embodiment, the lamp 300 has the first and second electrodes formed at the first and second end portions 310a, 310b, respectively, of the lamp body 310. The first and second electrodes of lamp 300 have a substantially identical structure.

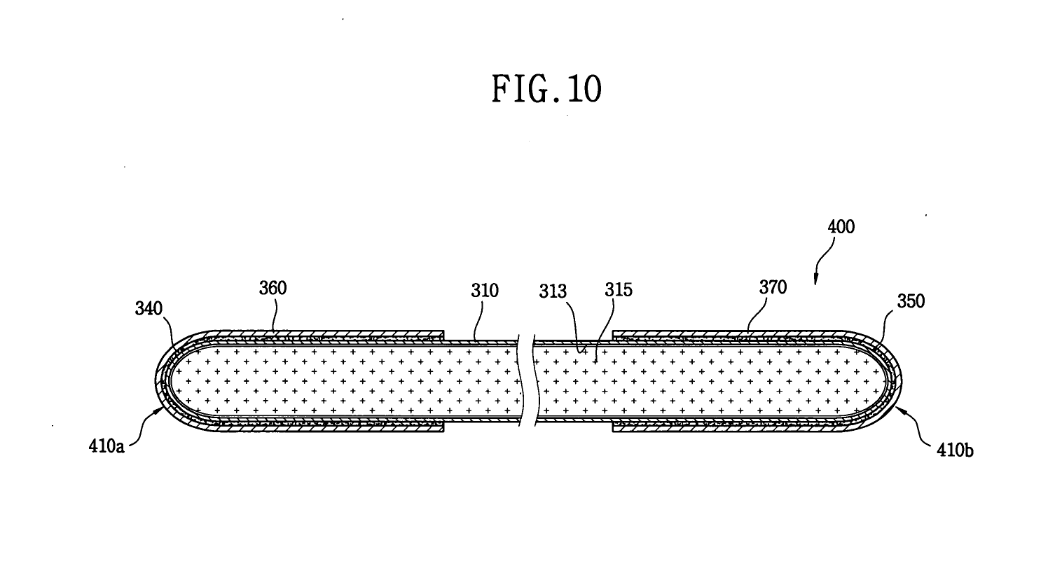

FIG. 10 is a cross-sectional view of a lamp according to another exemplary embodiment of the present invention. The lamp 400 in FIG. 10 is the same as the lamp 300 in FIG. 8 except for the first and third members 360, 370 of the first and second electrodes. Thus, the same reference numerals in FIGS. 8 and 10 represent the same parts and the detailed description thereof will be omitted.

Referring to FIG. 10, the first and third members 360, 370 each have a tube shape with the ends of which one is opened and the other is closed. The surface area of the first and third members 360, 370 of the lamp 400 in FIG. 10 is larger than that of the first and third members 320, 330 of the lamp 300 in FIG. 8. As the surface area of the first and third members 360, 370 is larger, the driving voltage for emitting electrons at the electrodes is lowered. Thus, the power consumption of the lamp 400 is reduced.

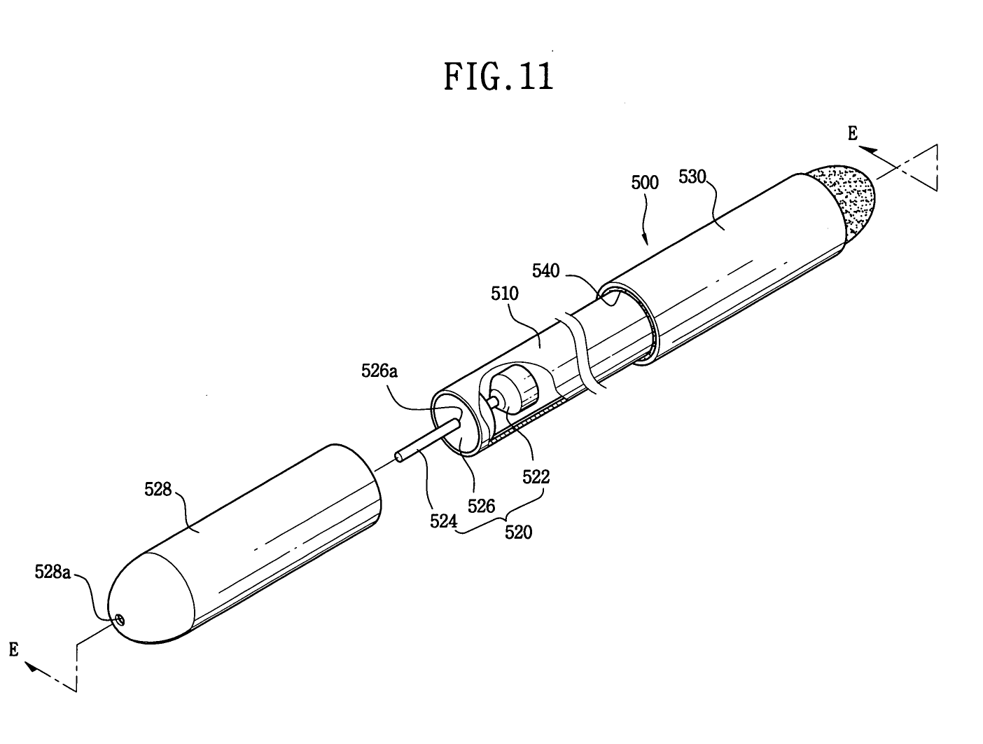

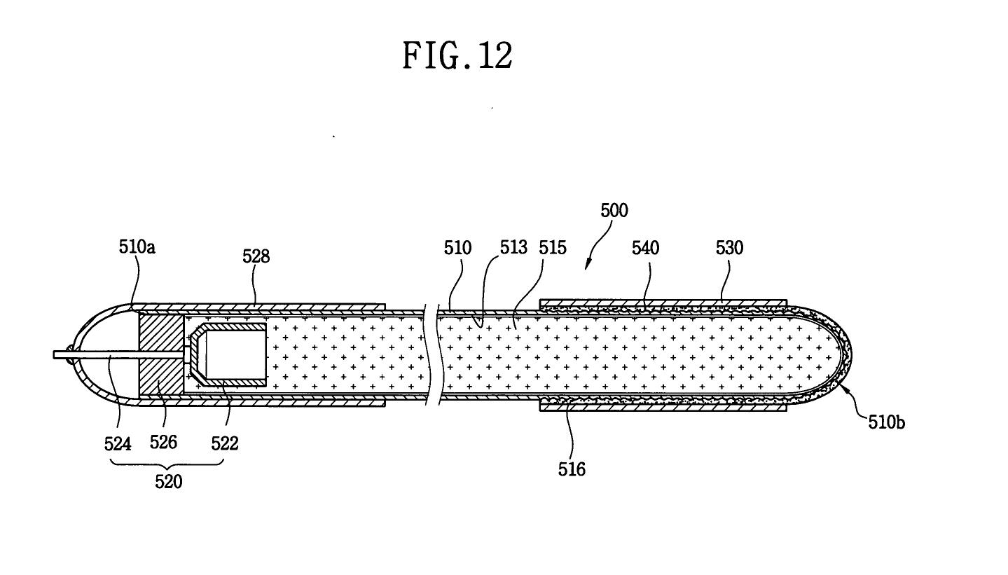

FIG. 11 is a partially exploded, perspective view of a lamp according to another exemplary embodiment of the present invention, and FIG. 12 is a cross-sectional view of the lamp taken along line E-E′ in FIG. 11. Referring to FIGS. 11 and 12, the lamp 500 includes a lamp body 510 and two electrodes at the end portions, respectively, of the lamp body 510. In this embodiment, the first electrode is formed at the first end portion 510a of the lamp body 510, and the second electrode is formed at the second end portion 510b of the lamp body 510.

The lamp body 510 has a tube shape with sealed ends. The lamp body 510 may be straight, L-shaped or U-shaped. The lamp body 510 includes a fluorescent layer 513 and a discharge gas 515. The fluorescent layer 513 is coated on the inner surface of the lamp body 510. The fluorescent layer 513 transforms an invisible ray such as ultraviolet ray into a visible ray. The fluorescent layer 513 includes red, green and blue fluorescent material in the form of a mixture. The red, green and blue fluorescent material emits red, green and blue light, respectively. The red, green and blue fluorescent materials each have a substantially amount, so that the fluorescent layer 513 emits white light.

The discharge gas 515 is injected into the lamp body 510, such that the lamp body 510 has a predetermined internal pressure of the discharge gas. The discharge gas 515 is ionized by being discharged in the form of plasma. The discharge gas 315 includes, for example, a small amount of Argon (Ar), Neon (Ne), Xenon (Xe), Krypton (Kr) or a mixture thereof, and may further include mercury (Hg).

The first electrode of the lamp 500 includes a first member 520 formed at the first end portion 510a of the lamp body 510 and the second member 528 receiving the first member 520. The first member 520 includes an electrode body 522, a lead wire 524 and a sealing member 526. The electrode body 522 has a cup-shape. In particular, the electrode body 522 has a cylindrical shape of which one end is open and the other end is closed. The electrode body 522 is disposed within the lamp body 510 at the first end portion 510a. The electrode body 522 is made of material including, for example, cupper (Cu), Nickel (Ni), Nickel alloy, or a mixture thereof. In case that the electrode body 522 includes cupper (Cu), the cupper (Cu) of the electrode body 522 reacts on hydrogen gas included in the discharge gas 515 to form an amalgam. The amalgam is then accumulated on the electrode body 510. As a result, a density of the hydrogen gas in the discharge gas 515 decreases, so that the luminance of the lamp 500 decreases. Thus, metal with relatively lower work function, such as nickel (Ni) or nickel alloy, is preferable to cupper (Cu).

The sealing member 526 is disposed at the first end portion 510a of the lamp body 510 to seal the end. The discharge gas 515 is confined in the lamp body 510 by sealing the end of the lamp body 510 with the sealing member 526. The sealing member 526 has a diameter substantially identical with that of the lamp body 510.

The lead wire 524 is extended from one end of the electrode body 522 to the second member 528 of the first electrode through the sealing member 526. The lead wire 524 has one end connected to the electrode body 522 and the other end connected to the second member 528 and is securely held by the sealing member 526. The lead wire 524 is drawn out through a hole 526a formed at a predetermined position of the sealing member 526. The lead wire is also extended out of the second member 528 through a hole 528a formed at the end of the second member 528. The lead wire 524 may be combined with the end of the second member 528 by soldering. The part of the lead wire 524 protruded outside the second member 528 constitutes a contact part of the lamp 500. In other words, a driving voltage is applied to the contact part and transferred to the electrode body 522 through the lead wire 524. The lead wire 524 is made of material including, for example, nickel (Ni).

The second member 528 of the first electrode has a cylindrical shape of which one end is open and the other end is closed. The second member 528 receives the first end portion 510a of the lamp body 510 such that the inner surface of the second member 528 is in contact with the outer surface of the lamp body 510.

The second electrode of the lamp 500 includes a third member 530 having a tube shape with open ends and a fourth member 540 formed on the surface of the lamp body 510 at the second end portion 510b. The third member 530 has the open ends to received the second end portion of the lamp body 510 on which the fourth member 540 is coated.

In this embodiment, the third member 530 has a thickness enough not to be removed from the lamp body 510. For example, the third member 530 has a thickness in the range from about 0.1 mm to about 0.2 mm. The third member 530 is made of material including, for example, nickel (Ni) or nickel alloy. Also, the third member 530 may be a brass tube or a brass tube with gold coating.

If a gap is formed between the third member 530 and the lamp body 510, a driving voltage applied to the third member 530 is not transferred to the lamp body 510. Also, the third member 530 may be easily removed from the lamp body 510. To prevent such a gap and removal, the fourth member 540 is formed at the second electrode of the lamp 500.

The fourth member 540 is formed on the surface of the second end portion 510b of the lamp body 510. The fourth member 540 is interposed between the lamp body 510 and the third member 530. The fourth member 540 is also melted and coated on the lamp body 510 so that the third member 530 is prevented from being detached from the lamp body 510. The fourth member 540 is made of material having a melting point effectively lower than that of the material of the third member 530. For example, the material of the fourth member 540 includes lead (Pb). By employing the fourth member 540 and such formation method, the third member 530 is not separated from the lamp body 510 even when the lamp 500 is used for a prolonged time period. Also, there is no decrease in the luminance of the lamp 500.

The fourth member 540 of the second electrode may be made of material having thermoset plastic with silver (Ag) beads. By disposing such member between the lamp body 510 and the third member 530, the thermoset plastic provides adhesion between the lamp body 510 and the third member 530, and the silver beads provide electrical connection between the lamp body 510 and the third member 530. However, when the thermoset plastic is repeatedly subjected to a thermal impact, it becomes fragile and its polymer becomes hardened so as to be easily broken. As a result, a gap is formed and increased between the lamp body 510 and third member 530 so that the third member 530 is detached from the lamp body 510.

In contrast, since the fourth member 540 in this embodiment is melted and coated on the lamp body 510, the fourth member 540 is not hardened or broken by the thermal impact so that the third member 530 is not detached from the lamp body 510 and there is no decrease in the luminance of the lamp 500. For example, the fourth member 540 is made of material including electrically conductive nonferrous metal, alloyed nonferrous metal or alloyed metal, of which melting point is lower than that of the third member 530.

In particular, the material of the fourth member 540 may include leadless metal (Pb free metal) mixed with tin (Sn) and zinc (Zn), lead mixed with silver (Ag), lead, alloyed lead, or a mixture thereof.

An electrode connecting portion 516 is formed at the second end portion 510b of the lamp body 510 to increase adhesive force between the fourth member 540 and the lamp body 510. The electrode connecting portion 516 of the lamp body 510 has a rough surface to increase the surface area and its roughness. As a result, the adhesion between the lamp body 510 and the fourth member 540 is increased.

The second end portion of the lamp body 510 is dipped into chemicals such as hydrogen fluoride and hydrofluoric acid to form the electrode connecting portion 516. In another way, small particles such as sands collide against the second end portion of the lamp body 510 to form the electrode connecting portion 516. Other chemical or mechanical methods may be used to form the electrode connecting portion 516.

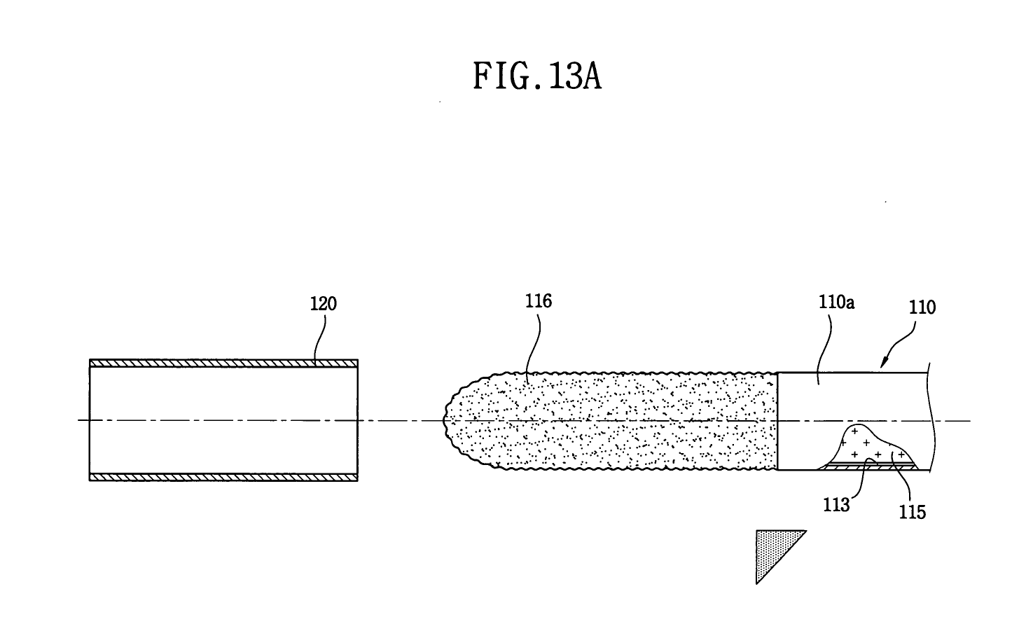

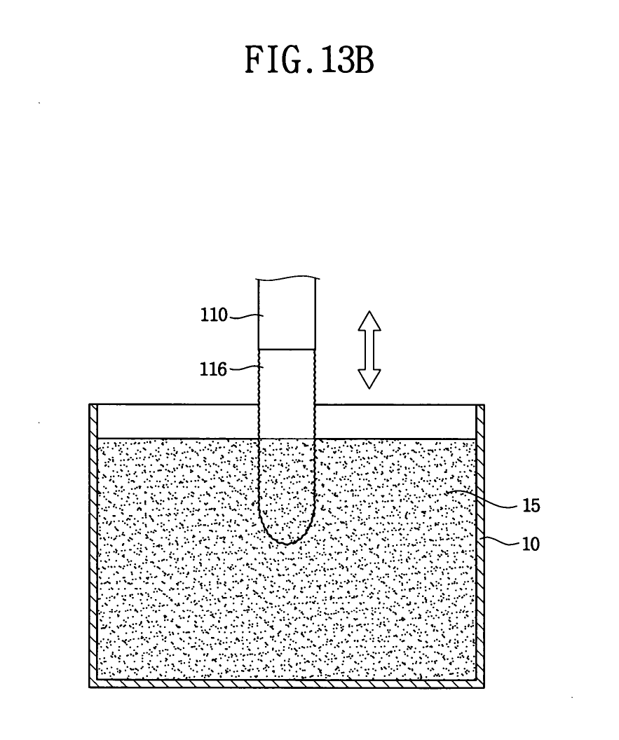

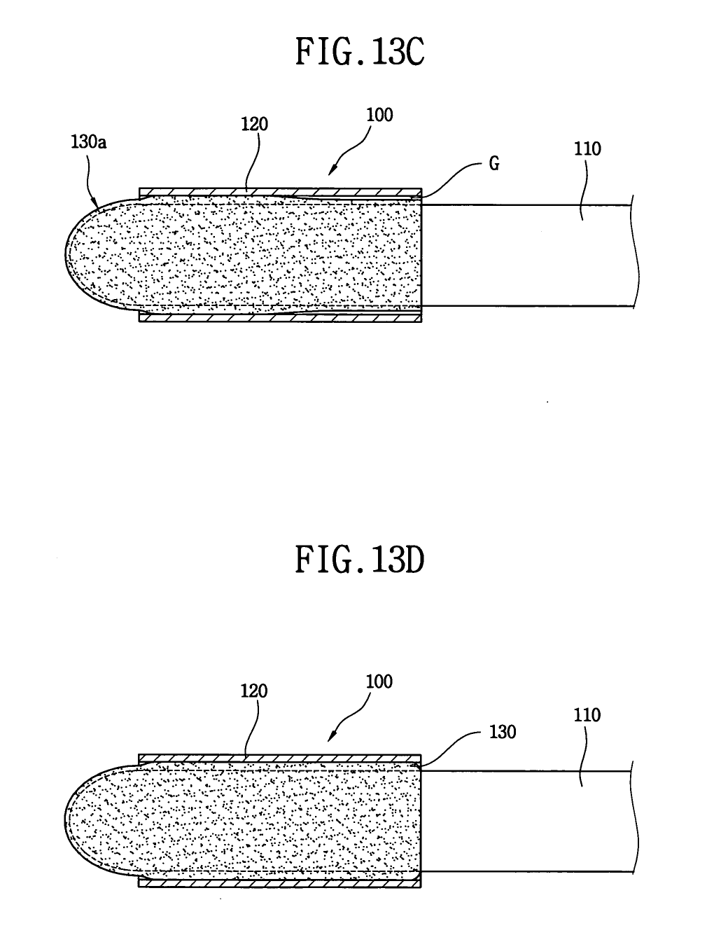

FIGS. 13A to 13D are schematic views for describing a process of manufacturing the lamp in FIG. 1 according to an embodiment of the present invention. FIG. 13A is a schematic view illustrating the lamp body 110 and the first electrode member 120 of the lamp. The fluorescent layer 113 is formed at the inner surface of a transparent tube 10a.

The fluorescent layer 113 includes the red, green and blue fluorescent materials in a mixture form, each of which has a substantially same amount. The fluorescent material is coated on the inner surface of the transparent tube 110a to form a thin layer thereon. The fluorescent layer 113 transforms an ultraviolet light into a visible light.

The discharge gas 115 is injected into the transparent tube 110a, and then the lamp body 110 is sealed. The discharge gas 115 includes, for example, mercury (Hg) gas. The electrode connecting portion 116 is formed at the first end portion of the lamp body 110 to enhance the adhesive force between the lamp body 110 and the second electrode member 130 (referring to FIG. 3). The first end portion of the lamp body 110 may be dipped into chemicals such as hydrogen fluoride and hydrofluoric acid to form the electrode connecting portion 116. The lamp body 110 is made of material including glass. Thus, when the first end portion of the lamp body 110 is dipped into the hydrogen fluoride or the hydrofluoric acid, the first end portion of the lamp body 110 is eroded, so that the surface of the first end portion becomes rough. In another way of forming the electrode connecting portion 116, small particles such as sands may collide against the end portion of the lamp body 110 to make the surface of the end portion rough.

The first electrode member 120 is a metal tube formed by processing a metal plate with a thickness from about 0.1 mm to about 0.2 mm through a rolling process or an injection molding process. The first electrode member 120 has a tube shape with the open ends. It should be noted that the electrode member of the lamp body 110 is not limited to the first electrode member 120 with the open ends as shown in FIGS. 13A to 13D. The electrode member of the lamp body 110 may have different shapes, for example, a tube shape with the ends of which one is opened and the other is closed as shown in FIG. 10.

The first electrode member 120 is made of metal that is not apt to be oxidized, such as nickel (Ni) and nickel alloy. The first electrode member 120 may also include brass. In case that the first electrode 120 is made of brass, a gold (Au) film may be coated in a few μm thickness on the surface of the brass to enhance the electrical properties of the electrode.

A conductive layer is formed at the first end portion of the lamp body 110. For example, the conductive layer is formed by coating the end portion of the lamp body 110 with conductive material of which melting point is lower than that of the lamp body 110. The conductive material includes, for example, lead (Pb), leadless metal (Pb free metal) mixed with tin (Sn) and zinc (Zn), lead mixed with silver (Ag), alloyed lead, or a mixture thereof.

FIG. 13B is a schematic view showing a process of coating a conductive layer on the end portion of the lamp body. Conductive material 15, such as lead (Pb), leadless metal (Pb free metal) mixed with tin (Sn) and zinc (Zn), lead mixed with silver (Ag), or alloyed lead, is melted in a melting furnace 10. The end portion of the lamp body 110 is dipped into the melted conductive material 15 for a predetermined time. Then, the end portion of the lamp body 110 is drawn out from the melted conductive material 15, and cooled to form a conductive layer.

The coating process described above may be repeated to increase the thickness of the conductive layer. The thickness of the conductive layer is non-uniform because the melted conductive material flows downward when the melted conductive material is not hardened. Thus, the thickness of the conductive layer varies at different areas. In other words, the closer to the center of the lamp body, the smaller the thickness of the conductive layer, and the closer to the end portion of the lamp body, the larger the thickness of the conductive layer.

FIG. 13C is a cross-sectional view of the lamp with the conductive layer having a non-uniform thickness. As shown in FIG. 13C, when the conductive layer 130a having a non-uniform thickness is formed at the end portion of the lamp body 110 and the end portion of the lamp body 110 is inserted into the first electrode member 120, a gap G is formed between the conductive layer 130a and the first electrode member 120 due to the non-uniformity of the conductive layer 130a.

FIG. 13D is a cross-sectional view of the lamp with a conductive layer having a uniform thickness. Referring to FIGS. 13C and 13D, the end portion of the lamp body 110 is heated to melt the conductive layer 130a. Since the first electrode member 120 has a melting point higher than that of the conductive layer 130a, the first electrode member 120 is not melt but the conductive layer 130a is melt. As a result, the gap G is filled with the melted conductive layer 130a. When the lamp body 110 is cooled, the conductive layer 130a is hardened to form the second electrode member 130 having a uniform thickness. A driving voltage applied to the first electrode member 120 is applied to the lamp body 110 via the second electrode member 130 made of the conductive material.

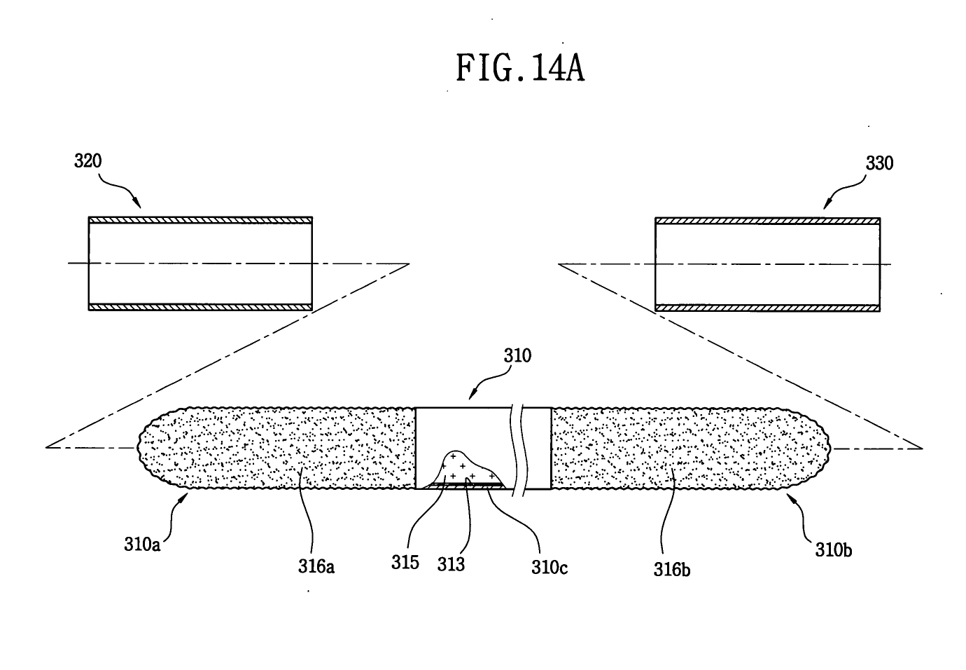

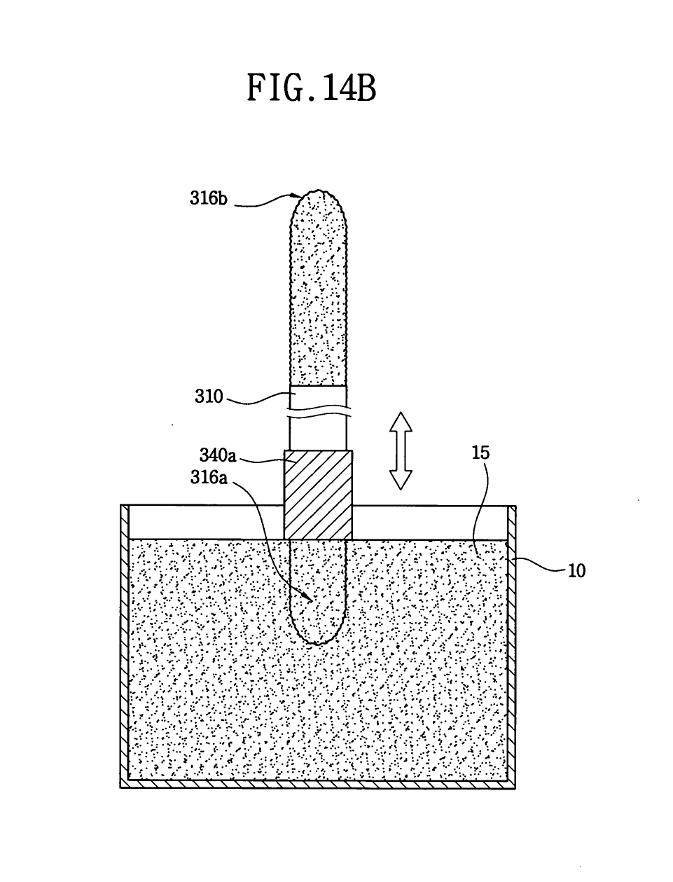

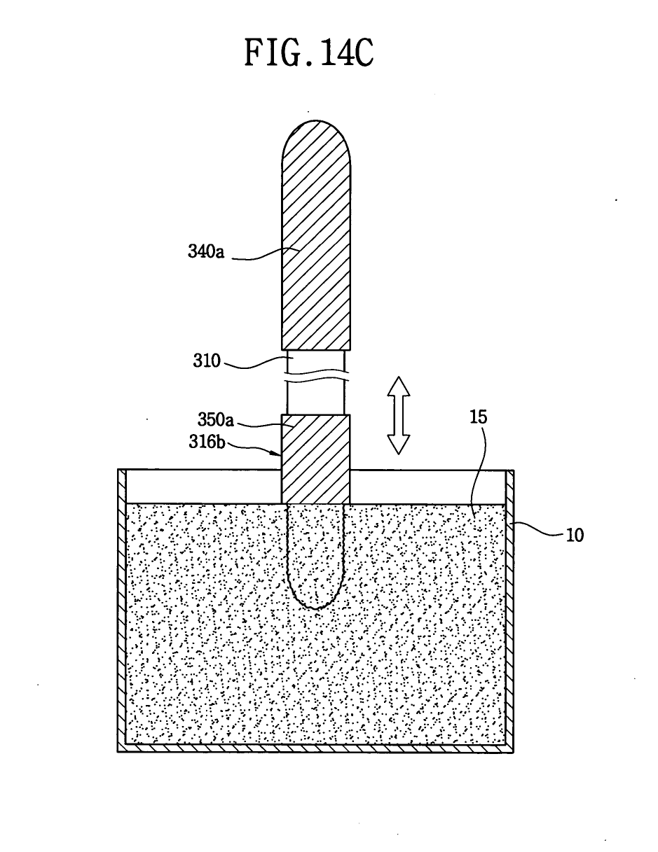

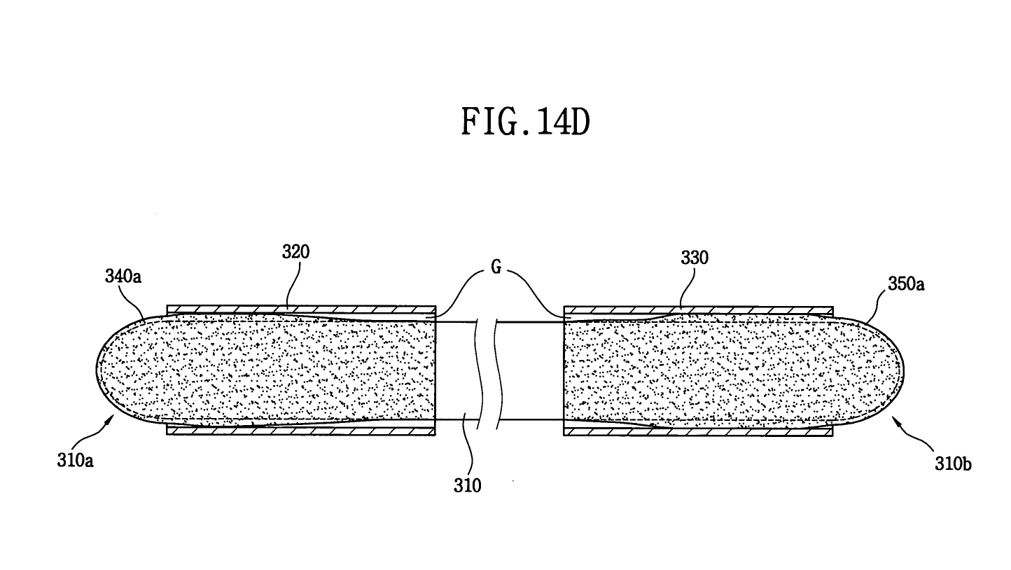

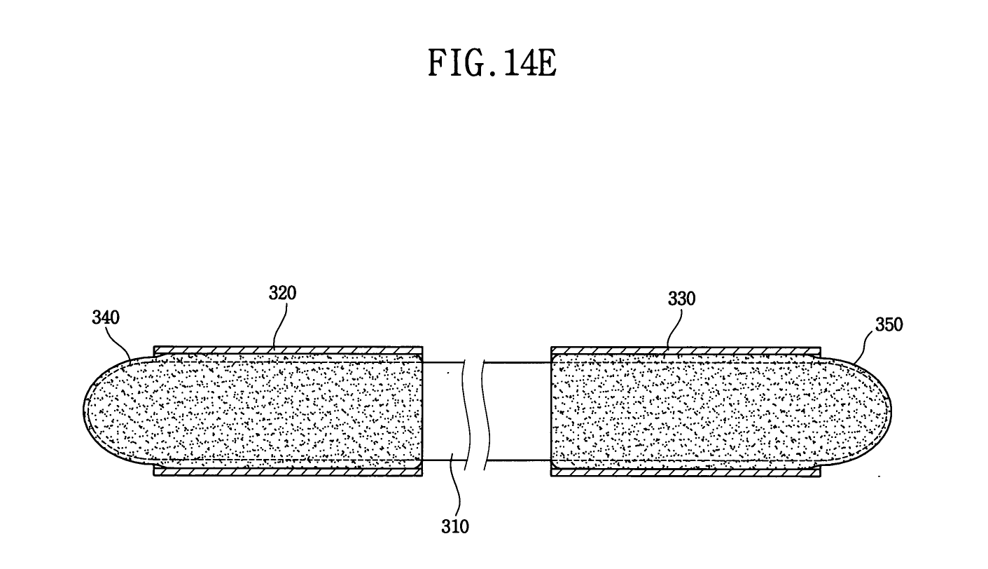

FIGS. 14A to 14E are schematic views for describing a process of manufacturing the lamp in FIG. 6 according to an embodiment of the present invention. FIG. 14A is a schematic view illustrating the lamp body 310 and the first and third members of the lamp 300. Referring to FIG. 14A, the fluorescent layer 313 is formed at the inner surface of the transparent tube 310c. The fluorescent layer 313 includes the red, green and blue fluorescent materials, each of which has the substantially same amount. The fluorescent layer 313 transforms an ultraviolet light into a visible light. The discharge gas 315 is injected into the transparent tube 310c, and then the lamp body 310 is sealed. The discharge gas 315 includes, for example, mercury (Hg) gas.

The first electrode connecting portion 316a is formed at the first end portion 310a of the lamp body 310 to enhance the adhesive force between the lamp body 310 and the second member 340 (referring to FIG. 8) of the first electrode. The second electrode connecting portion 316b is formed at the second end portion 310b of the lamp body 310 to enhance the adhesive force between the lamp body 310 and the fourth member 350 (referring to FIG. 8) of the second electrode.

The first and second end portions 310a, 310b of the lamp body 310 are dipped into chemicals such as hydrogen fluoride and hydrofluoric acid to form the first and second electrode connecting portions 316a, 316b. Since the lamp body 310 is made of material including glass, the first and second end portions 310a, 310b of the lamp body 310 are eroded when the first and second end portions 310a, 310b are dipped into the hydrogen fluoride or the hydrofluoric acid. As a result, the surfaces of the first and second end portions 310a, 310b become rough. In a different way, small particles such as sands may collide against the end portions of the lamp body 310 to form the first and second electrode connecting portions 316a, 316b.

The first and third members 320, 330 are metal tubes each made by processing a metal plate having a thickness from about 0.1 mm to about 0.2 mm through a pressing process, a rolling process or an injection molding process. The first and third members 320, 330 each have a tube shape with the open ends. It should be noted that the shape of the electrode members of the lamp body 310 is not limited to that of the first and third members 320, 330 with the open ends as shown in FIGS. 14D and 14E. The electrode members of the lamp body 310 may have different shapes, for example, a tube shape with the ends of which one is opened and the other is closed as shown in FIG. 10. The first and third members 320, 330 are made of material including metal that is not apt to be oxidized, such as nickel (Ni) and nickel alloy. The material of the first and third members 320, 330 may also include brass. In case that the first and third members 320, 330 are made of brass, a gold (Au) film may be coated in a few μm thickness on the surface of the brass to enhance the electrical properties of the first and second electrodes.

A conductive layer is formed at each of the first and second end portions 310a, 310b of the lamp body 310. The conductive layer is formed by coating the surfaces of the first and second end portions of the lamp body 310 with conductive material of which melting point is lower than the lamp body 310. For example, the conductive material includes lead (Pb), leadless metal (Pb free metal) mixed with tin (Sn) and zinc (Zn), lead mixed with silver (Ag), alloyed lead, or a mixture thereof.

FIG. 14B is a schematic view showing a process of coating a first conductive layer on the first end portion of the lamp body. The conductive material 15, such as Lead (Pb), leadless metal (Pb free metal) mixed with tin (Sn) and zinc (Zn), lead mixed with silver (Ag), or alloyed lead, is melted in a melting furnace 10. The first end portion 310a of the lamp body 310 is dipped into the melted conductive material 15 for a predetermined time. Then, the first end portion 310a of the lamp body 310 is drawn out from the melted conductive material 15 and cooled to form the first conductive layer 340a. The coating process described above may be repeated to increase the thickness of the conductive layer. The thickness of the first conductive layer 340a is non-uniform, because the melted conductive material flows downward when the melted conductive material is not hardened. Thus, the thickness of the first conductive layer 340a is larger at the area closer to the first end portion 310a than at the area closer to the center of the lamp body 310.

FIG. 14C is a schematic view showing a process of coating a second conductive layer on the second end portion of the lamp body. The conductive material 15 is melted in the melting furnace 10, and the second end portion 310b of the lamp body 310 is dipped into the melted conductive material 15 for a predetermined time. Then, the second end portion 310b of the lamp body 310 is drawn out from the melted conductive material 15 and cooled to form the second conductive layer 350a. This coating process may be repeated to increase the thickness of the second conductive layer 350a. The thickness of the second conductive layer 350a is non-uniform, because the melted conductive material flows downward when the melted conductive material is not hardened. Thus, the thickness of the second conductive layer 350a is larger at the area closer to the second end portion 310b than at the area closer to the center of the lamp body 310.

FIG. 14D is a cross-sectional view of the lamp with the first and second conductive layers each having a non-uniform thickness. Referring to FIG. 14D, the first and second conductive layers 340a, 350a each having a non-uniform thickness are formed at the first and second end portions 310a, 310b of the lamp body 310, respectively. Then, the first and second end portions 310a, 310b of the lamp body 310 are inserted into the first and third members 320, 330 respectively. In this case, as shown in FIG. 14D, a gap G is formed between the first conductive layer 340a and the first member 320 due to the non-uniformity of the first conductive layer 340a. Another gap G is also formed between the second conductive layer 350a and the third member 330 due to the non-uniformity of the second conductive layer 350a. The gap may result in problems such that the first and third members 320, 330 are separated from the lamp body 310 and/or a driving voltage applied to the first and third members 320, 330 is not transferred to the lamp body 310.

FIG. 14E is a cross-sectional view of the lamp with first and second conductive layers having a uniform thickness. Referring to FIGS. 14D and 14E, the lamp body 310 with the first and third members 320, 330 is heated, so that first and second conductive layers 340a, 350a are melted. Then, the gap G is filled with the melted conductive layers 340a, 350a. When the lamp body 310 is cooled, the first and second conductive layers 340a, 350a are hardened to form the second and fourth members 340, 350 each having a uniform thickness.

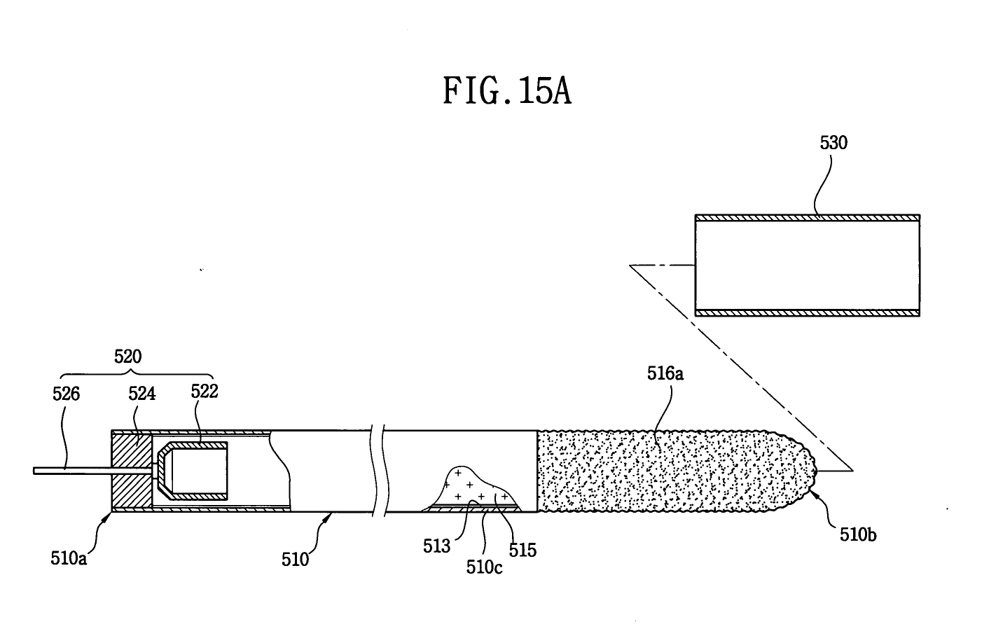

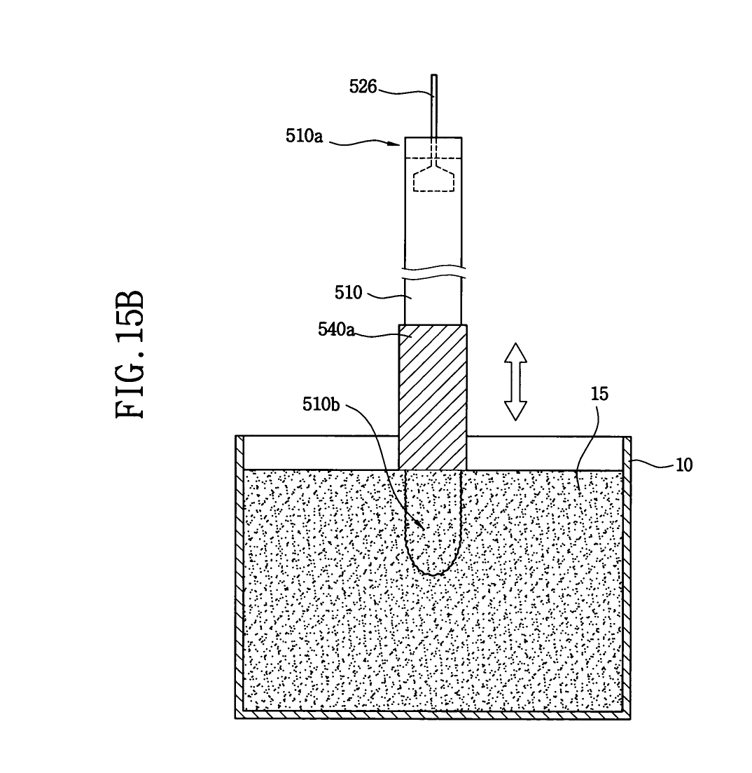

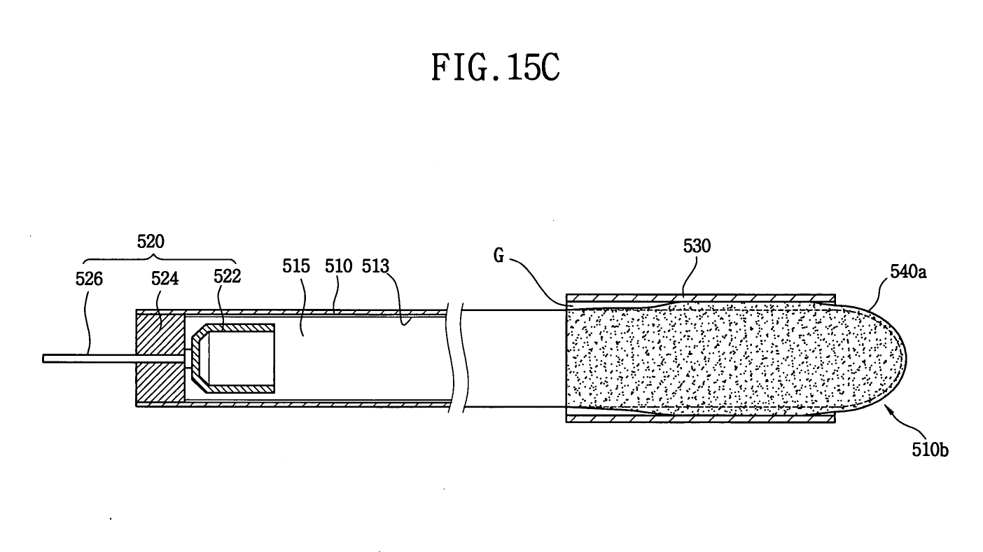

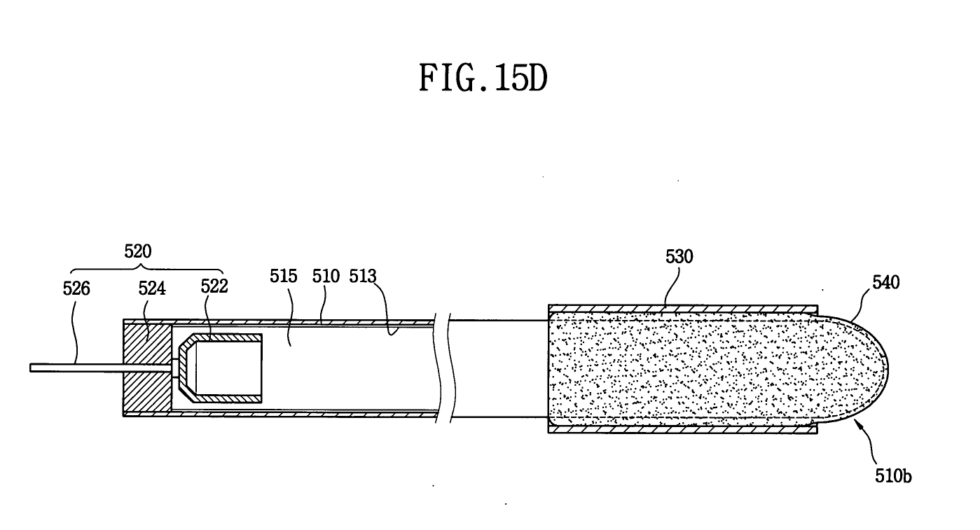

FIGS. 15A to 15D are schematic views for describing a process of manufacturing the lamp in FIG. 11 according to an embodiment of the present invention. FIG. 15A is a schematic view of the lamp body 510 and the first and second electrodes of the lamp. Referring to FIG. 15A, the fluorescent layer 513 is formed on the inner surface of the transparent tube 510c. The fluorescent layer 513 includes the red, green and blue fluorescent materials in a mixture form, each of which has the substantially same amount. The fluorescent layer 513 transforms ultraviolet light into visible light.

The lead wire 526 is connected to the electrode body 522 and is extended to penetrate the sealing member 524. Then, the discharge gas 515 is injected into the transparent tube 510c. The sealing member 524 then seals the first end portion 510a of the lamp body 510.

The electrode connecting portion 516a is formed at the second end portion 510b of the lamp body 510, so that the adhesive force between the lamp body 510 and the third member 530 (referring to FIG. 12) is enhanced. The second end portion 510b of the lamp body 510 is dipped into chemicals such as hydrogen fluoride and hydrofluoric acid to form the electrode connecting portion 516a. Since the lamp body 510 includes glass, the second end portion 510b of the lamp body 510 is eroded when the second end portion 510b is dipped into the hydrogen fluoride or the hydrofluoric acid. As a result, the surface of the first end portion becomes rough. In another way, small particles such as sands may collide against the second end portion 510b of the lamp body 510 to form the electrode connecting portion 516a.

The third member 530 of the second electrode is a metal tube made by processing a metal plate with a thickness from about 0.1 mm to about 0.2 mm through a pressing process, a rolling process or an injection molding process. The third member 530 has a tube shape with the open ends. The third member 530 is made of material including metal that is not apt to be oxidized, such as nickel (Ni) and nickel alloy. The third member 530 may be made of material including brass. In case that the third member 530 is made of brass, a gold (Au) film having a few μm thickness may be coated on the surface of the brass to enhance electrical properties of the second electrode. It should be noted that the shape of the electrode member of the lamp body 510 is not limited to that of the third member 530 with the open ends as shown in FIGS. 15C and 15D. The electrode member of the lamp body 510 may have different shapes, for example, a tube shape with the ends of which one is opened and the other is closed as shown in FIG. 10.

A conductive layer is formed at the second end portion 510b of the lamp body 510. The conductive layer is formed by coating the surface of the lamp body 510 with conductive material having a melting point lower than that of the lamp body 510. For example, the conductive material includes lead (Pb), leadless metal (Pb free metal) mixed with tin (Sn) and zinc (Zn), lead mixed with silver (Ag), alloyed lead, or a mixture thereof.

FIG. 15B is a schematic view showing a process of coating the conductive layer on the second end portion of the lamp body. The conductive material 15, such as Lead (Pb), leadless metal (Pb free metal) mixed with tin (Sn) and zinc (Zn), lead mixed with silver (Ag), or alloyed lead, is melted in the melting furnace 10. The second end portion 510b of the lamp body 510 is dipped into the melted conductive material 15 for a predetermined time. Then, the second end portion 510b of the lamp body 510 is drawn out from the melted conductive material 15 and cooled to form the conductive layer 540a.

The coating process described above may be repeated to increase the thickness of the conductive layer 540a. The thickness of the conductive layer 540a is non-uniform, because the melted conductive material flows downward when the melted conductive material is not hardened. Thus, the thickness of the second conductive layer 350a varies in different areas such as it is larger at the area closer to the second end portion 510b than at the area closer to the center of the lamp body 510.

FIG. 15C is a cross-sectional view of the lamp with a conductive layer having a non-uniform thickness. Referring to FIG. 15C, the conductive layer 540a having a non-uniform thickness is formed at the second end portion 510b of a lamp body 510, and the second end portion 510b of the lamp body 510 is combined with the third member 530 of the second electrode. In this case, a gap G is formed between the conductive layer 540a and the third member 530 due to the non-uniformity of the conductive layer 540a. The gap G may result in problems such that the third member 530 is separated from the lamp body 510 and/or a driving voltage applied to the third member 530 is not transferred to the lamp body 510.

FIG. 15D is a cross-sectional view of the lamp with a conductive layer having a uniform thickness. Referring to FIGS. 15C and 15D, the lamp body 510 with the third member 530 is heated, so that the conductive layer 540a is melted. Thus, the gap G is filled with the melted conductive layer 540a. When the lamp body 510 is cooled, the conductive layer 540a is hardened to form the fourth member 540 having a uniform thickness. A driving voltage applied to the third member 530 is applied to the lamp body 510 via the fourth member 540 in the second electrode.

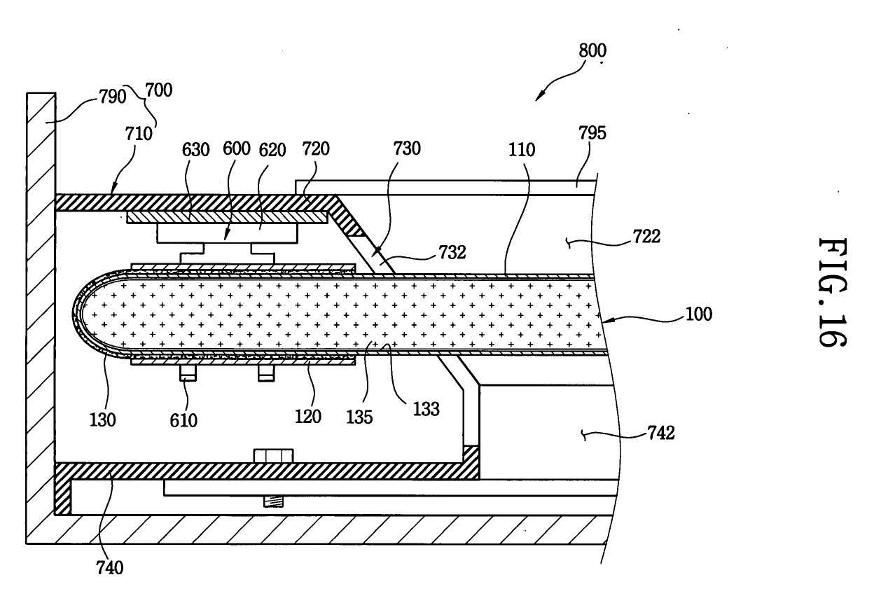

FIG. 16 is a cross-sectional view showing a portion of a backlight assembly according to an embodiment of the present invention. Referring to FIG. 16, a backlight assembly 800 includes a lamp 100, a voltage applying module 600 and a receiving container 700. It should be noted that although the backlight assembly 800 in this embodiment employs the lamp 100 shown in FIGS. 1-4, the backlight assembly 800 of the present invention may employ any of the lamps described above. In FIG. 16, the lamp 100 includes the lamp body 110, the first electrode member 120, and the second electrode member 130. The first electrode member 120 is disposed at the first end portion of the lamp body 110. The second electrode member 130 is interposed between the lamp body 110 and the first electrode member 120 to provide an electrical connection therebetween.

The receiving container 700 receives the lamp 100 and the voltage applying module 600. The receiving container 700 includes a first receiving container 710 and a second receiving container 790. The first receiving container 710 receives the lamp 100 and the voltage applying module 600. The second receiving container 790 receives the first receiving container 710. The first receiving container 710 is made of, for example, plastics. The first receiving container 710 includes a first frame 720, a connection frame 730 and a second frame 740. The first frame 720 has a rectangular shape having an opening 722 through which the light generated from the lamp 100 passes. The second frame 740 is disposed at the opposite side of the first frame 720 with respect to the lamp 100. The second frame 740 has a rectangular shape having an opening 742. The connection frame 730 connects the first frame 720 and the second frame 740. In particular, the connection frame 730 connects the inner edge of the first frame 720 and the inner edge of the second frame 740. The connection frame 730 includes receiving grooves 732 of which number is the same as that of the lamps 100. For example, the backlight assembly 800 may have 10 to 20 lamps arranged in parallel. The receiving grooves 732 are formed at the positions respectively corresponding to those of the lamps 100. A pair of receiving grooves, one formed at the first electrode of the lamp and the other formed at the second electrode of the lamp, receive a corresponding one of the lamps.

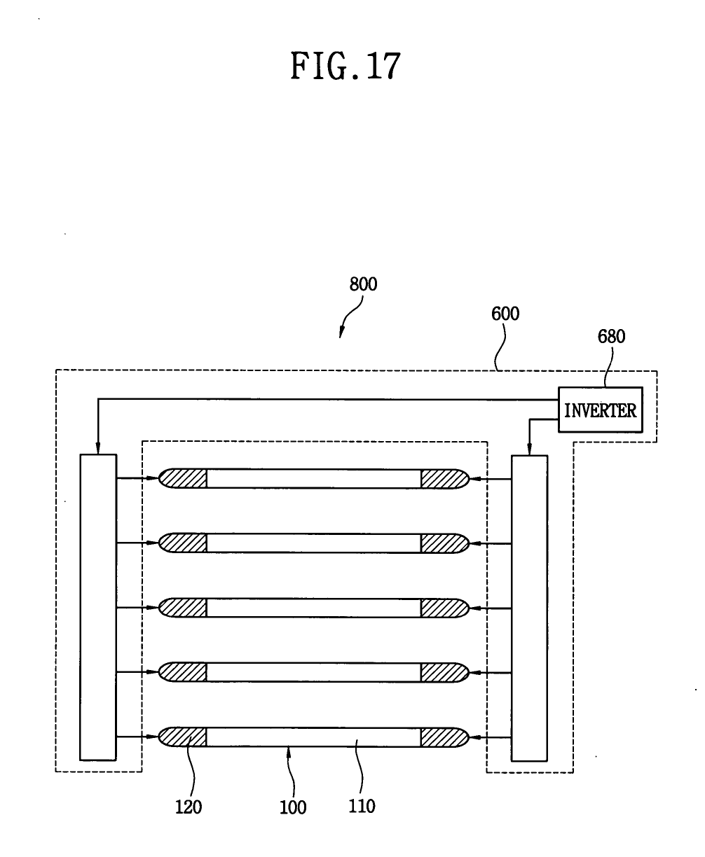

FIG. 17 is a schematic view showing the voltage applying module 600 and the lamps 100 of FIG. 16. Referring to FIG. 17, the voltage applying module 600 applies a driving voltage to lamps 100 which are electrically connected to the voltage applying module 600 in parallel. An inverter 680 provides the driving voltage to the voltage applying module 600. The voltage applying module 600 in this embodiment has two sub-parts for proving the driving voltage to the electrodes of the lamps 100. The sub-parts of the voltage applying module 600 are arranged substantially parallel with each other and substantially perpendicular to the longitudinal direction of the lamps 100.

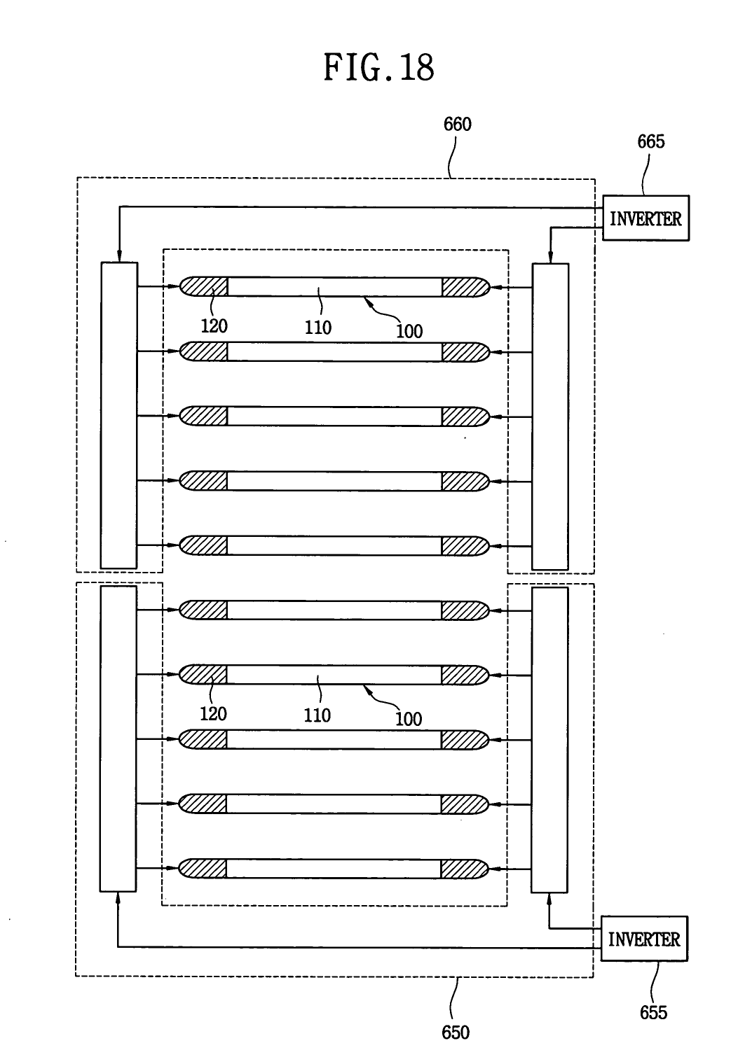

FIG. 18 is a schematic view showing an arrangement of two voltage applying modules and the lamps 100. In this embodiment, the backlight assembly includes two voltage applying modules 650, 660 each providing a driving voltage to a group of the lamps 100. In case that the number of the lamps 100 is over the capacity of one inverter, it is necessary to provide, for example, two inverters 655, 665 in the backlight assembly. In this case, the two inverters 655, 665 each provide a driving voltage to the corresponding one of the voltage applying modules 650, 660, which then provides the driving voltage to the corresponding group of the lamps 100.

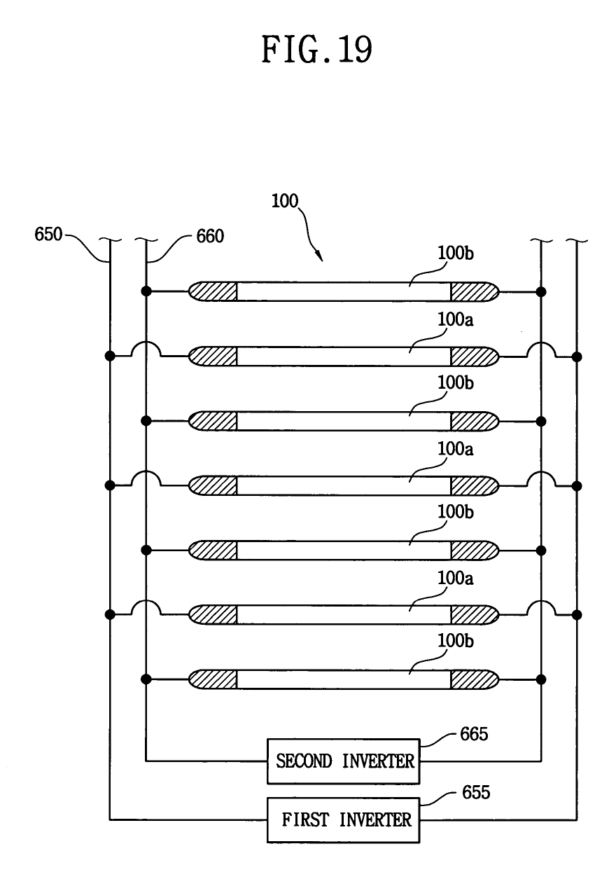

FIG. 19 is a schematic view showing another arrangement of two voltage applying modules and the lamps. In this embodiment, the first and second inverters 655 and 665 drive the first group of lamps 110a and the second group of lamps 110b, respectively. The first group of lamps 100a are connected to the first voltage applying module 650, and the second group of lamps 100b are connected to the second voltage applying module 660. The first and second voltage applying modules 650, 660 receive the driving voltage from the first and second inverters 655, 666, respectively.

In this embodiment, the lamps are arranged such that the lamps of one group alternate with the lamps of the other group as shown in FIG. 19. Such arrangement of the lamps is advantageous in that the backlight assembly provides the entire area of a display panel with light having uniform distribution, even when one of the two groups is in trouble.

Referring again to FIG. 16, the voltage applying module 600 is disposed between the first frame 720 and the lamp 100. The voltage applying module 600 includes an electric conductor 620 and a lamp clip 610. The electric conductor 620 has a band shape extending in a direction substantially perpendicular to the longitudinal direction of the lamp 100. The electric conductor 620 is a thin metal plate. The lamp clip 610 grips a first electrode member 120 of the lamp 100. The lamp clip 610 is attached on the electric conductor 620 to hold the lamp 100 at a predetermined position in the receiving container 700, and the lamp clip 610 provides an electrical connection between the electric conductor 620 and the first electrode member 120. The lamp clip 610, for example, includes a pair of arms each having an arcuate shape to grip the outer surface of the first electrode member 120. The lamp clip 610 receives lamp 100 through its open portion and securely holds it.

It is noted that although the voltage applying module 600 of the embodiment in FIG. 16 is disposed between the first frame 720 and the lamp 100, the voltage applying module may be disposed differently in different embodiments. For example, the voltage applying module is disposed between the second frame 740 and the lamp 100. In this case, the voltage applying module with the electric conductor and the lamp clip is securely disposed on the second frame 740.

The backlight assembly also includes a diffusion plate 795 for diffusing light from the lamp 100 to make the light have a uniform luminance distribution. Since each of the lamps arranged in parallel generates linear light, the luminance of the light from the lamps is not uniform. In other words, the luminance at a region adjacent to a lamp is higher than that at a region between the adjacent lamps. The diffusion plate 795 is placed over lamps 100 so that the light passing through the diffusion plate 795 has a uniform luminance. The first frame 720 supports an edge portion of the diffusion plate 795.

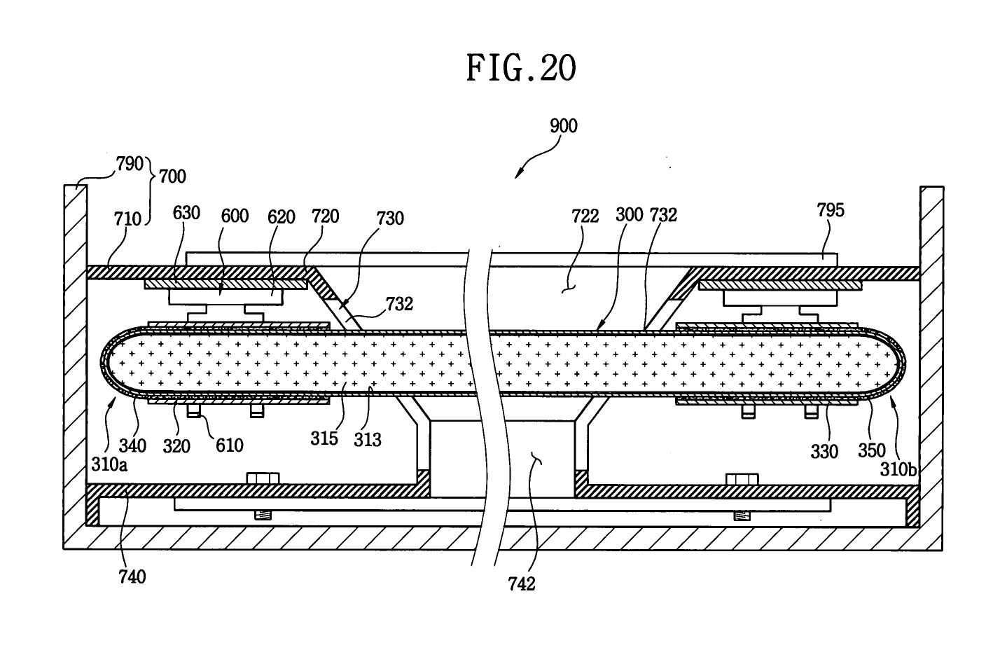

FIG. 20 is a cross-sectional view showing a backlight assembly according to another exemplary embodiment of the present invention. In this embodiment, the backlight assembly 900 includes the lamp 300 in FIG. 6. However, it is noted that the backlight assembly 900 may employ any of the lamps described above. The backlight assembly 900 also includes the voltage applying module 600 and the receiving container 700 that are substantially identical with those in FIG. 16.

The lamp 300 includes the lamp body 310, the first electrode having the first and second members 320, 340, the second electrode having the third and fourth members 330, 350. The first member 320 is disposed at the first end portion 310a of the lamp body 310, and the second member 340 is interposed between the lamp body 310 and the first 20 member 320. The third member 330 is disposed at the second end portion 310b of the lamp body 310, and the fourth member 350 is interposed between the lamp body 310 and the third member 330. The second member 340 combines the first member 320 and the lamp body 310, and the fourth member 350 combines the third member 330 and the lamp body 310.

The receiving container 700 receives the lamp 300 and the voltage applying module 600. The receiving container 700 includes the first receiving container 710 and the second receiving container 790. The first receiving container 710 receives the lamp 300 and the voltage applying module 600. The second receiving container 790 receives the first receiving container 710. The first receiving container 710 includes the first and second frames 720, 740 and the connection frame 730 connecting them each other. In other words, the connection frame 730 connects the inner edge of the first frame 720 with the inner edge of the second frame 740. The connection frame 730 has the receiving grooves 732 each to receive corresponding one of the lamps 300.

The voltage applying module 600 is disposed between the first frame 720 and the lamp 300. The voltage applying module 600 includes the electric conductor 620 and the lamp clip 610. The electric conductor 620 is a thin metal plate and has a band shape extending in a direction substantially perpendicular to the longitudinal direction of the lamps 300. The lamp clip 610 grips the first member 320 of the lamp 300. The lamp clip 610 is attached on the electric conductor 620 and provides an electrical connection between the electric conductor 620 and the first member 320 of the lamp 300. The lamp clip 610, for example, includes a pair of arms each having an arcuate shape to grip the outer surface of the first member 320. The lamp clip 610 receives lamp 300 through its open portion and securely holds it.

It is noted that although the voltage applying module 600 of the embodiment in FIG. 20 is disposed between the first frame 720 and the lamp 300, the voltage applying module may be disposed differently in different embodiments. For example, the voltage applying module is disposed between the second frame 740 and the lamp 300. In this case, the voltage applying module with the electric conductor and the lamp clip is securely disposed on the second frame 740.

The above described parts are disposed at the both sides of the backlight assembly to receive and hold the lamps and to provide a driving voltage to the respective electrodes of the lamps. In other words, the first electrode of each lamp is held by the receiving container 700 and provided with the driving voltage by the voltage applying module 600 in one side of the backlight assembly, and the second electrode of each lamp is also held and provided with the driving voltage by the same parts in the other side of the backlight assembly.

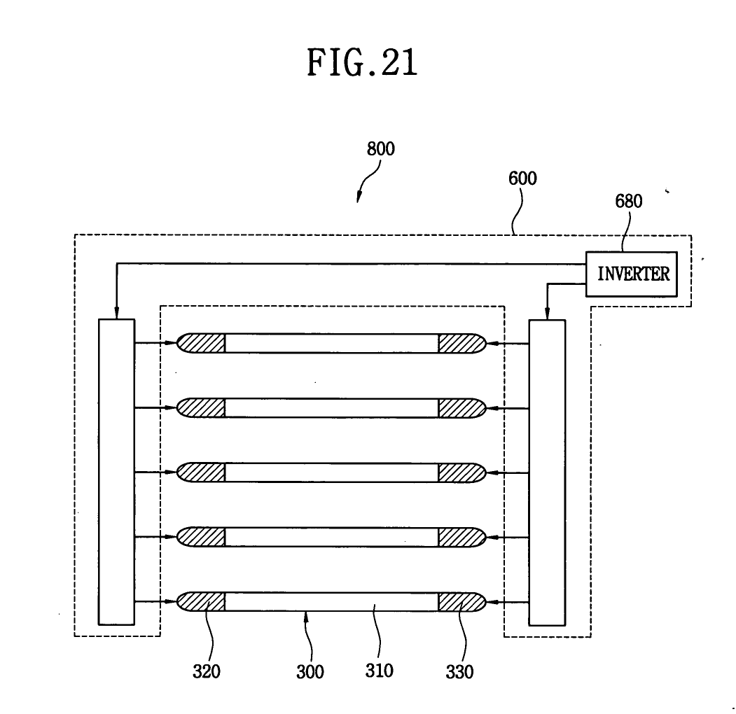

FIG. 21 is a schematic view showing the voltage applying module and the lamps of FIG. 20. Referring to FIG. 21, the voltage applying module 600 applies a driving voltage to lamps 300 which are electrically connected to the voltage applying module 600 in parallel. An inverter 680 provides the driving voltage to the voltage applying module 600. The voltage applying module 600 in this embodiment has two sub-parts for proving the driving voltage to the electrodes of the lamps 300. The sub-parts of the voltage applying module 600 are arranged substantially parallel with each other and substantially perpendicular to the longitudinal direction of the lamps 300.

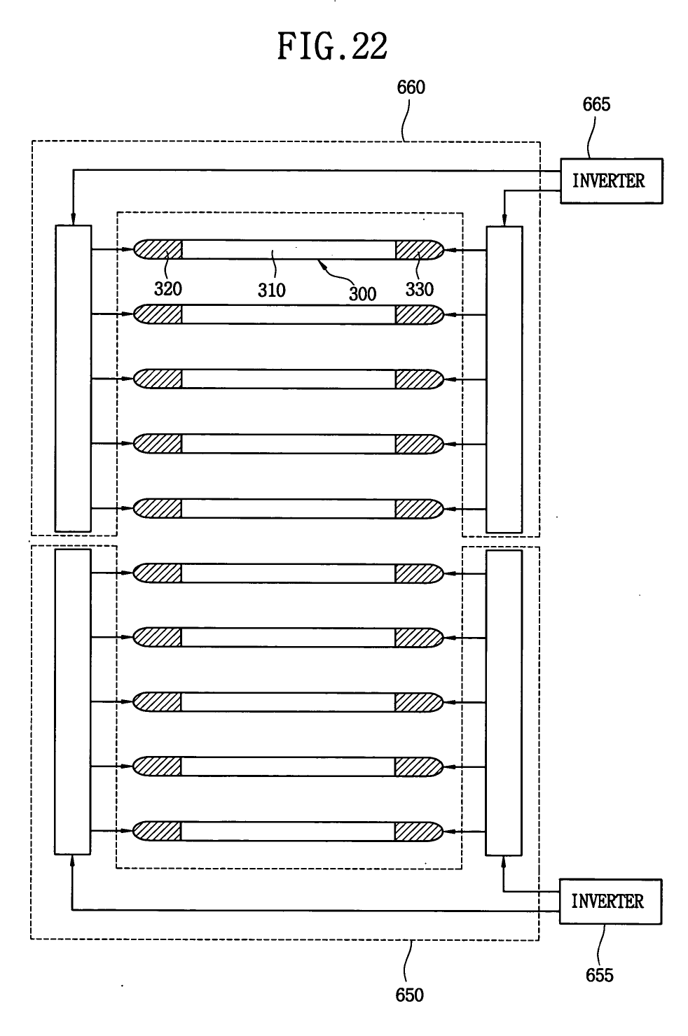

FIG. 22 is a schematic view showing an arrangement of two voltage applying modules and the lamps 300. In this embodiment, the backlight assembly includes two voltage applying modules 650, 660 each providing a driving voltage to a group of the lamps 300. In case that the number of the lamps 300 is over the capacity of one inverter, it is necessary to provide, for example, two inverters 655, 665 in the backlight assembly. In this case, the two inverters 655, 665 each provide a driving voltage to the corresponding one of the voltage applying modules 650, 660, which then provides the driving voltage to the corresponding group of the lamps 300. In this embodiment, the first inverter 655 provides the driving voltage to the first and second electrodes of the first group of the lamps via the first voltage applying module 650, and the second inverter 665 provides the driving voltage to the first and second electrodes of the second group of the lamps via the second voltage applying module 660.

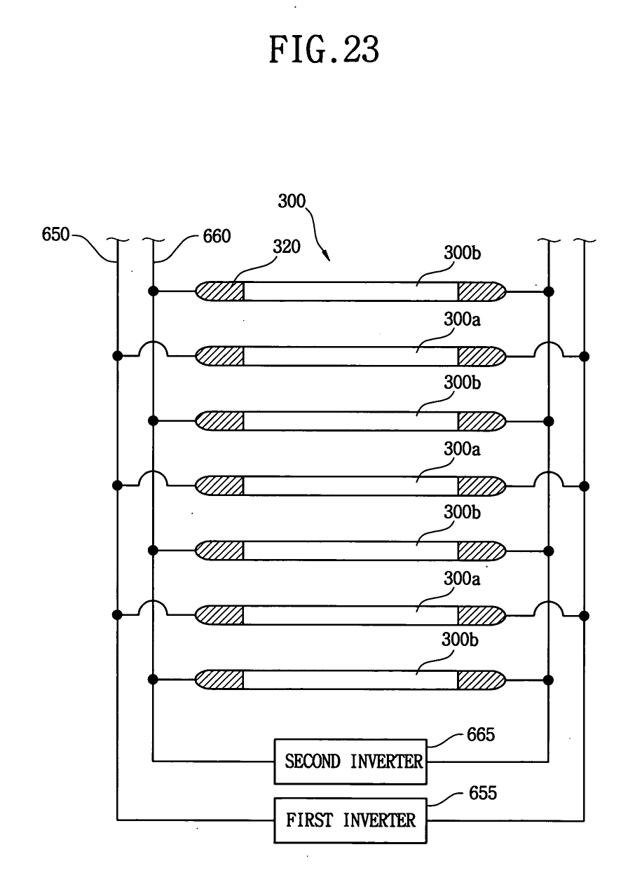

FIG. 23 is a schematic view showing another arrangement of two voltage applying modules and the lamps. In this embodiment, the first and second inverters 655 and 665 drive the first group of lamps 300a and the second group of lamps 300b, respectively. The first group of lamps 300a are connected to the first voltage applying module 650, and the second group of lamps 300b are connected to the second voltage applying module 660. The first and second voltage applying modules 650, 660 receive the driving voltage from the first and second inverters 655, 666, respectively.

In this embodiment, the lamps are arranged such that the lamps of one group alternate with the lamps of the other group as shown in FIG. 23. Such arrangement of the lamps is advantageous in that the backlight assembly provides the entire area of a display panel with light having uniform distribution, even when one of the two groups is in trouble.

The backlight assembly also includes a diffusion plate 795 for diffusing light from the lamp 300 to make the light have a uniform luminance distribution. Since each of the lamps arranged in parallel generates linear light, the luminance of the light from the lamps is not uniform. In other words, the luminance at a region adjacent to a lamp is higher than that at a region between the adjacent lamps. The diffusion plate 795 is placed over lamps 300 so that the light passing through the diffusion plate 795 has a uniform luminance. The first frame 720 supports an edge portion of the diffusion plate 795.

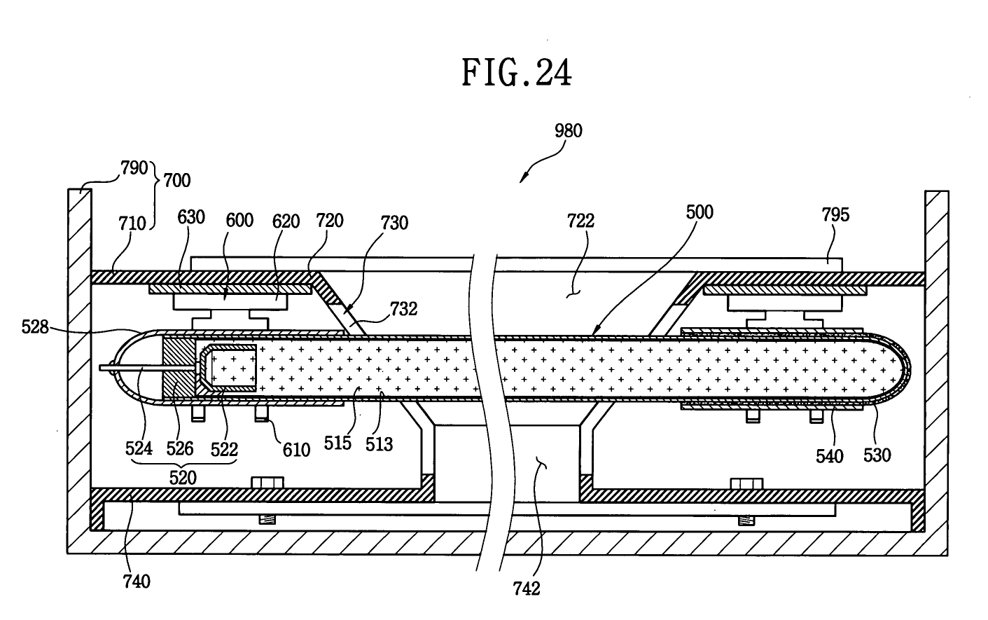

FIG. 24 is a cross-sectional view showing a backlight assembly according to another exemplary embodiment of the present invention. Referring to FIG. 24, the backlight assembly 980 employs the lamp 500 in FIG. 11 and the voltage applying module 600 and the receiving container 700.

The lamp 500 includes the lamp body 510, the first electrode having the first and second members 520, 528, and second electrode having third and fourth members 530, 540. The first member 520 is disposed within the lamp body 510 at the first end portion 510a, and the second member 528 receives the first end portion 510a of the lamp body 510 and the first member 520 of the first electrode. The third member 530 is disposed at the second end portion 510b of the lamp body 510, and the fourth member 540 is interposed between the lamp body 510 and the third member 530. The fourth member 540 connects the third member 530 and the lamp body 510.

The receiving container 700 receives the lamp 500 and the voltage applying module 600. The receiving container 700 includes the first receiving container 710 receiving the lamp 500 and the voltage applying module 600 and the second receiving container 790 receiving the first receiving container 710. The first receiving container 710 includes the first and second frames 720, 740 and the connection frame 730 connecting them each other. In other words, the connection frame 730 connects the inner edge of the first frame 720 with the inner edge of the second frame 740. The connection frame 730 has the receiving grooves 732 each to receive corresponding one of the lamps 500.

The voltage applying module 600 is disposed between the first frame 720 and the lamp 500. The voltage applying module 600 includes the electric conductor 620 and the lamp clip 610. The electric conductor 620 is a thin metal plate and has a band shape extending in a direction substantially perpendicular to the longitudinal direction of the lamps 500. The lamp clip 610 grips the second member 528 of the lamp 500. The lamp clip 610 is attached on the electric conductor 620 and provides an electrical connection between the electric conductor 620 and the second member 528 of the lamp 500. The lamp clip 610, for example, includes a pair of arms each having an arcuate shape to grip the outer surface of the second member 528. The lamp clip 610 receives lamp 500 through its open portion and securely holds it.

It is noted that although the voltage applying module 600 of the embodiment in FIG. 24 is disposed between the first frame 720 and the lamp 500, the voltage applying module may be disposed differently in different embodiments. For example, the voltage applying module is disposed between the second frame 740 and the lamp 500. In this case, the voltage applying module with the electric conductor and the lamp clip is securely disposed on the second frame 740.

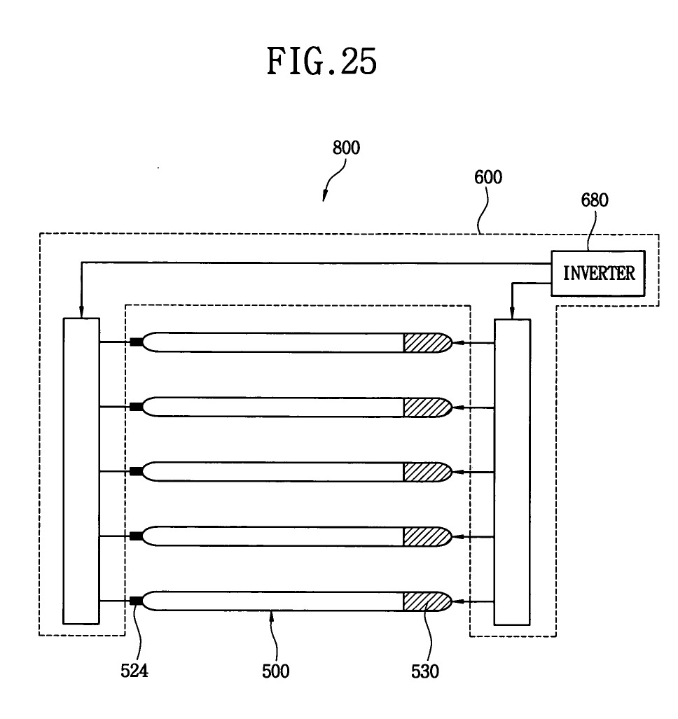

FIG. 25 is a schematic view showing the voltage applying module and the lamps of FIG. 24. Referring to FIG. 25, the voltage applying module 600 applies a driving voltage to lamps 500 which are electrically connected to the voltage applying module 600 in parallel. An inverter 680 provides the driving voltage to the voltage applying module 600. The voltage applying module 600 in this embodiment has two sub-parts for proving the driving voltage to the electrodes of the lamps 500. The sub-parts of the voltage applying module 600 are arranged substantially parallel with each other and substantially perpendicular to the longitudinal direction of the lamps 500.

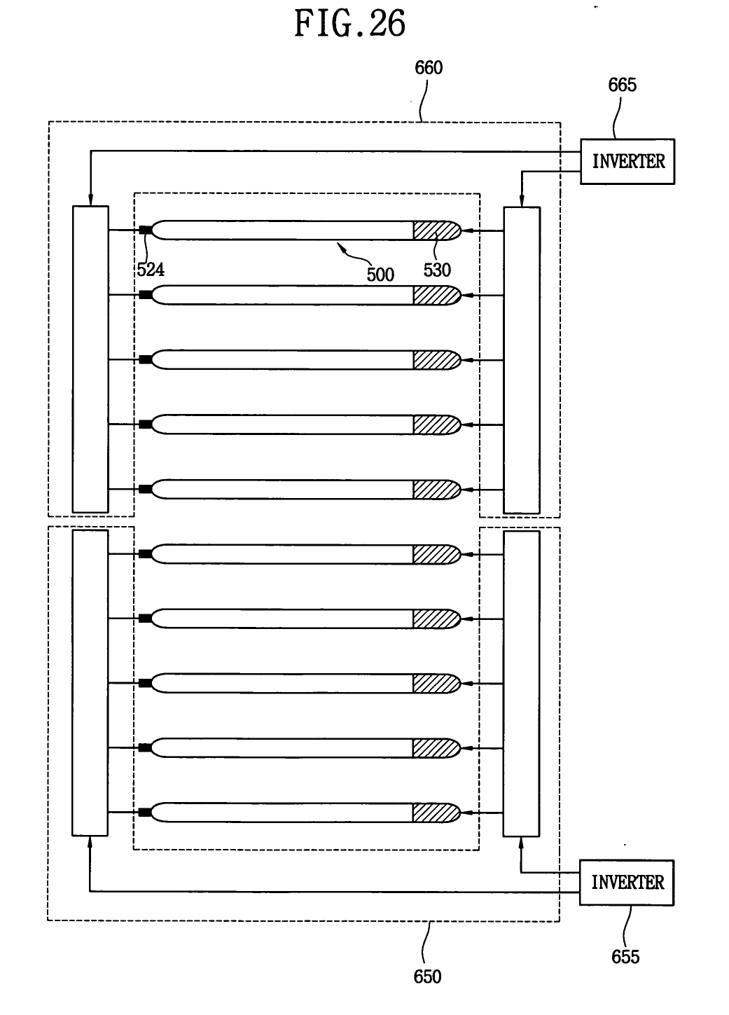

FIG. 26 is a schematic view showing an arrangement of two voltage applying modules and the lamps 500. In this embodiment, the backlight assembly includes two voltage applying modules 650, 660 each providing a driving voltage to a group of the lamps 500. In case that the number of the lamps 100 is over the capacity of one inverter, it is necessary to provide, for example, two inverters 655, 665 in the backlight assembly. In this case, the two inverters 655, 665 each provide a driving voltage to the corresponding one of the voltage applying modules 650, 660, which then provides the driving voltage to the corresponding group of the lamps 500. In this embodiment, the first inverter 655 provides the driving voltage to the first and second electrodes of the first group of the lamps via the first voltage applying module 650, and the second inverter 665 provides the driving voltage to the first and second electrodes of the second group of the lamps via the second voltage applying module 660.

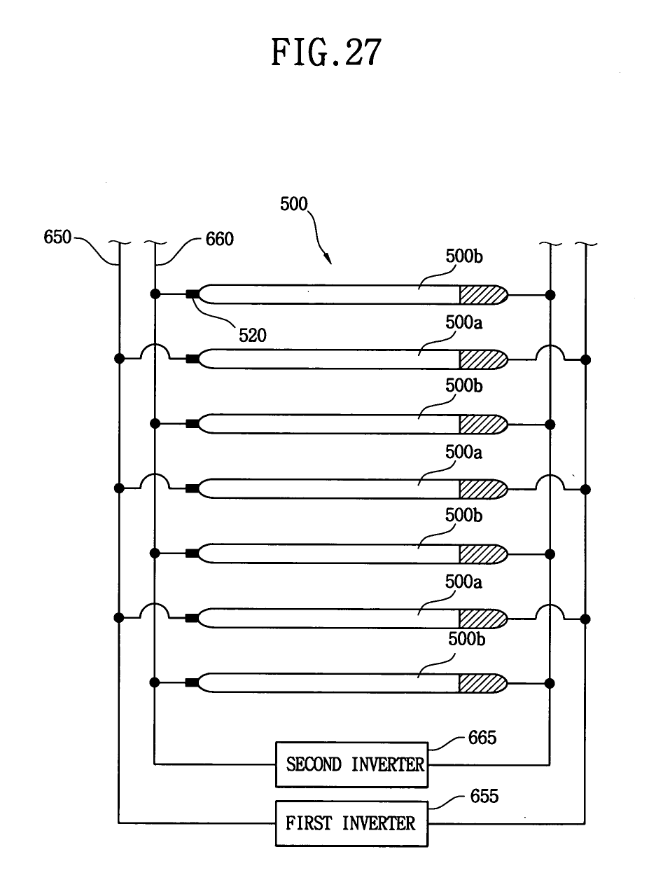

FIG. 27 is a schematic view showing another arrangement of two voltage applying modules and the lamps. In this embodiment, the first and second inverters 655 and 665 drive the first group of lamps 500a and the second group of lamps 500b, respectively. The first group of lamps 500a are connected to the first voltage applying module 650, and the second group of lamps 500b are connected to the second voltage applying module 660. The first and second voltage applying modules 650, 660 receive the driving voltage from the first and second inverters 655, 666, respectively.

In this embodiment, the lamps are arranged such that the lamps of one group alternate with the lamps of the other group as shown in FIG. 27. Such arrangement of the lamps is advantageous in that the backlight assembly provides the entire area of a display panel with light having uniform distribution, even when one of the two groups is in trouble.

The backlight assembly also includes the diffusion plate 795 for diffusing light from the lamp 500 to make the light have a uniform luminance distribution. Since each of the lamps arranged in parallel generates linear light, the luminance of the light from the lamps is not uniform. In other words, the luminance at a region adjacent to a lamp is higher than that at a region between the adjacent lamps. The diffusion plate 795 is placed over lamps 500 so that the light passing through the diffusion plate 795 has a uniform luminance. The first frame 720 supports an edge portion of the diffusion plate 795.

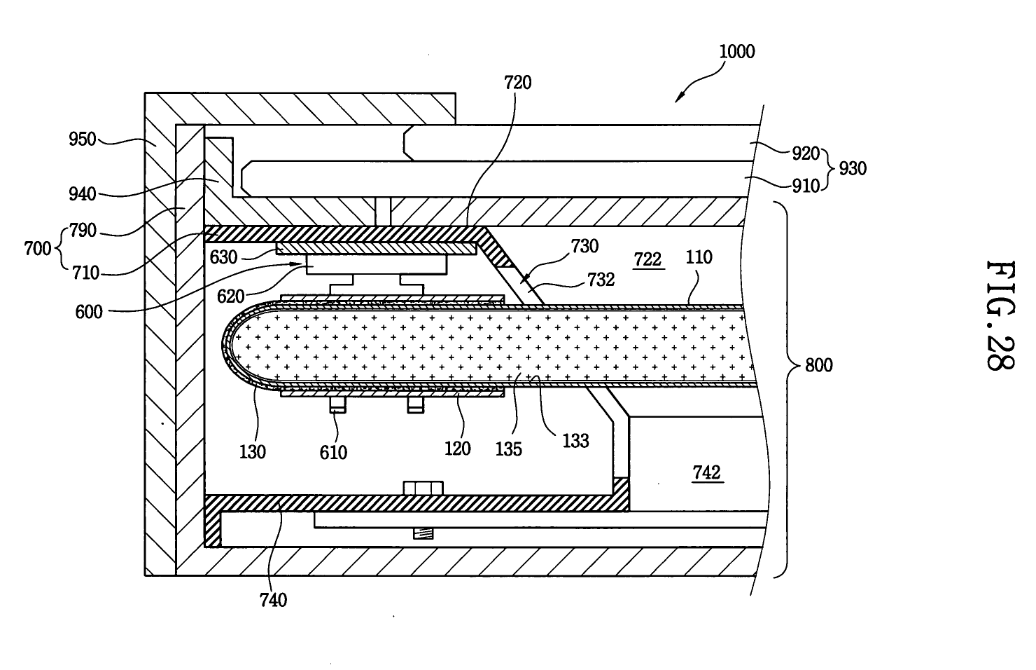

FIG. 28 is a cross-sectional view partially showing a liquid crystal display device according to an exemplary embodiment of the present invention. The liquid crystal display device in this embodiment employs the backlight assembly 800 in FIG. 16. It is noted, however, that the liquid crystal display device of the present invention may employ any of the backlight assemblies described above. In FIG. 28, the same parts as those shown in FIG. 16 are represented with like reference numerals and to avoid description duplication, accordingly, their explanation will be omitted.

Referring to FIG. 28, the liquid crystal display device 1000 includes the backlight assembly 800, a liquid crystal display panel 930, a middle chassis 940, and a chassis 950. The middle chassis 940 supports the liquid crystal display panel 930 and is disposed on the first frame 720 of the first receiving container 710. The middle chassis 940 receives the liquid crystal display panel 930 to combine the liquid crystal panel 930 with the backlight assembly 800.

The chassis 950 enwraps an edge portion of the liquid crystal display panel 930 and protects the liquid crystal display panel 930 that would be fragile. The chassis 950 is combined with the second receiving container 790 of the backlight assembly 800. The chassis 950 also prevents the liquid crystal display panel from being separated from the backlight assembly 800. It should be noted that although the present embodiment employs the middle chassis 940 and the chassis 950 as shown in FIG. 28, the liquid crystal display device of the present invention may employ different types of holding members for implementing the substantially same function. For example, a first holding member 940 is disposed between the liquid crystal display panel 930 and the backlight assembly 800 to securely hold the display panel 930 onto the backlight assembly 800, and a second holding member 950 is formed adjacent to the receiving container 700 to securely hold an edge of the display panel to prevent the display panel and the light assembly from being disassembled. The first and second holding members 940, 950 may be implemented in the type of a mold frame.

The liquid crystal display panel 930 displays images using the light generated from the backlight assembly 800 in combination with image data. The liquid crystal display panel 930 includes a thin film transistor (TFT) substrate 910, a liquid crystal layer and a color filter substrate 920. The thin film transistor substrate 910 includes pixel electrodes, thin film transistors, gate lines and data lines. The pixel electrodes are arranged in a matrix form. The color filter substrate 920 includes color filters and a common electrode formed on the color filters. The color filter substrate 920 is disposed on the thin film transistor substrate 910, such that color filters face the pixel electrodes, respectively. The liquid crystal layer is interposed between the thin film transistor substrate 910 and the color filter substrate 920.

As described above, the liquid crystal display device of the present invention employs the lamp having the solder electrode member interposed between the lamp body and the member of the electrode to which the driving voltage is applied. The solder electrode member is melted when it is heated, and is solidified when it is cooled. Thus, the solder electrode member combines the lamp body with the member receiving the driving voltage with an increased adhesive force therebetween.

Having described the embodiments of the lamp, the backlight assembly and the liquid crystal display device employing the same, and the method of manufacturing the same according to the present invention, modifications and variations can be readily made by those skilled in the art in light of the above teachings. It is therefore to be understood that, within the scope of the appended claims, the present invention can be practiced in a manner other than as specifically described herein.

What is claimed is:

1. A lamp for emitting light, comprising:
a lamp body in which a discharge gas is injected; and
first and second electrodes disposed at opposite ends of the lamp body, the first and second electrodes receiving current externally provided, wherein the first electrode includes:
a first member that receives a first end portion of the lamp body, the first member being electrically conductive; and
a second member disposed between the first member and the lamp body, the second member having metallic solder and being coated on the first end portion of the lamp body to provide adhesion between the first member and the lamp body.

2. The lamp of claim 1, wherein the first member of the first electrode has a tube shape of which opposite ends are open to receive the first end portion of the lamp body.

3. The lamp of claim 2, wherein the first member of the first electrode includes one of nickel, nickel alloy, brass or a mixture thereof.

4. The lamp of claim 3, wherein the first member of the first electrode includes a gold film coated on a surface of the first member.

5. The lamp of claim 1, wherein the second member of the first electrode is airtightly formed to prevent a void gap between the first member and the lamp body.

6. The lamp of claim 1, wherein the second member of the first electrode has a melting point lower than a melting point of the first member of the first electrode.

7. The lamp of claim 1, wherein the metallic solder of the second member includes one of leadless metal mixed with tin and zinc, lead mixed with silver, lead, lead alloy, and a mixture thereof.

8. The lamp of claim 1, wherein the first end portion of the lamp body has a rough surface on which the second member of the first electrode is coated, the rough surface increasing adhesion between the first end portion of the lamp body and the second member of the first electrode.

9. The lamp of claim 1, wherein the first member of the first electrode has a tube shape having opposite ends of which one is open and the other is closed.

10. The lamp of claim 9, wherein a size of entire inner surface of the first member of the first electrode is substantially identical with a size of entire outer surface of the second member of the first electrode.

11. The lamp of claim 9, wherein the first member of the first electrode has a thickness in a range from about 0.1 mm to 0.2 mm.

12. The lamp of claim 1, wherein the second electrode includes:
a third member that receives a second end portion of the lamp body, the third member being electrically conductive; and
a fourth member disposed between the third member and the lamp body, the fourth member having metallic solder and being coated on the second end portion of the lamp body to provide adhesion between the third member and the lamp body.

13. The lamp of claim 12, wherein the third member of the second electrode has a tube shape of which opposite ends are open to receive the first end portion of the lamp body.

14. The lamp of claim 12, wherein the fourth member of the second electrode is airtightly formed to prevent a void gap between the third member and the lamp body.

15. The lamp of claim 12, wherein the second end portion of the lamp body has a 15 rough surface on which the fourth member of the second electrode is coated, the rough surface increasing adhesion between the second end portion of the lamp body and the fourth member of the second electrode.

16. The lamp of claim 12, wherein the third member of the second electrode has a 20 tube shape having opposite ends of which one is open and the other is closed.

17. The lamp of claim 16, wherein a size of entire inner surface of the third member of the second electrode is substantially identical with a size of entire outer surface of the fourth member of the second electrode.

18. The lamp of claim 1, wherein the second electrode includes:
a third member disposed in a second end portion of the lamp body, the third member receiving a driving voltage externally provided; and
a fourth member that receives the second end portion of the lamp body in which the third member is disposed, the fourth member having a contact part through which the third member is in contact with a electric source providing the driving voltage.

19. The lamp of claim 18, wherein the third member of the second electrode includes:
an electrode body disposed in the discharge gas of the lamp body;
a lead wire that transfers the driving voltage to the electrode body; and
a sealing member that seals the second end portion of the lamp body to prevent a leak of the discharge gas and for holding the lead wire.

20. The lamp of claim 19, wherein the sealing member has a conduit through which the lead wire is extended from the electrode body to the fourth member.

21. The lamp of claim 19, wherein the contact part of the fourth member of the second electrode is a hole through which the lead wire is extended to be in contact with the electric source.

22. The lamp of claim 22, wherein the lead wire is soldered at the hole of the fourth member of the second electrode.

23. The lamp of claim 19, wherein the electrode body has a cup shape having opposite ends of which one is open and the other is closed and connected with the lead wire.

23. The lamp of claim 19, wherein the electrode body is made of material including one of cupper, nickel, nickel alloy, and a mixture thereof.

24. A light assembly for providing light, comprising:
a lamp including:
a lamp body in which a discharge gas is injected; and
first and second electrodes disposed at opposite ends of the lamp body, the first and second electrodes receiving a driving voltage externally provided, wherein the first electrode includes:
a first member that receives a first end portion of the lamp body, the first member being electrically conductive; and
a second member disposed between the first member and the lamp body, the second member having metallic solder and being coated on the first end portion of the lamp body to provide adhesion between the first member and the lamp body;
a voltage applying module that receives the driving voltage from an external source and providing the driving voltage to the first and second electrodes of the lamp; and
a receiving container that receives and securely holds the lamp and the voltage applying module.

25. The light assembly of claim 24, wherein the receiving container includes:
a first frame that receives the first electrode of the lamp; and
a first lamp clip that holds the first electrode of the lamp, the first lamp clip being attached to the first frame.

26. The light assembly of claim 25, wherein the first frame includes:
upper and lower parts between which the first electrode of the lamp is disposed; and
a connection part connected with the upper and lower parts, the connection part having an opening through which the first electrode of the lamp is inserted.

27. The light assembly of claim 24, wherein the voltage applying module is connected with a plurality of lamps each of which is substantially identical with the lamp, the plurality of the lamps being arranged parallel with each other with respect to the voltage applying module.

28. The light assembly of claim 27, wherein the first member of the first electrode has a tube shape of which opposite ends are open to receive the first end portion of the lamp body.

29. The light assembly of claim 27, wherein the second member of the first electrode is airtightly formed to prevent a void gap between the first member and the lamp body, and has a melting point lower than a melting point of the first member of the first electrode.

30. The light assembly of claim 27, wherein the metallic solder of the second member includes one of leadless metal mixed with tin and zinc, lead mixed with silver, lead, lead alloy, and a mixture thereof.

31. The light assembly of claim 27, wherein the first end portion of the lamp body has a rough surface on which the second member of the first electrode is coated, the rough surface increasing adhesion between the first end portion of the lamp body and the second member of the first electrode.

32. The light assembly of claim 27, wherein the first member of the first electrode has a tube shape having opposite ends of which one is open and the other is closed.

33. The light assembly of claim 32, wherein a size of entire inner surface of the first member of the first electrode is substantially identical with a size of entire outer surface of the second member of the first electrode.

34. The light assembly of claim 27, wherein the second electrode includes:
a third member that receives a second end portion of the lamp body, the third member being electrically conductive; and
a fourth member disposed between the third member and the lamp body, the fourth member having metallic solder and being coated on the second end portion of the lamp body to provide adhesion between the third member and the lamp body.

35. The light assembly of claim 34, wherein the receiving container includes:
a second frame that receives the second electrode of the lamp; and
a second lamp clip that holds the second electrode of the lamp, the second lamp clip being attached to the second frame.

36. The light assembly of claim 35, wherein the second frame includes:
upper and lower parts between which the second electrode of the lamp is disposed; and
a connection part connected with the upper and lower parts, the connection part having an opening through which the second electrode of the lamp is inserted.

37. The light assembly of claim 34, wherein the third member of the second electrode has a tube shape of which opposite ends are open to receive the first end portion of the lamp body.

38. The light assembly of claim 34, wherein the second end portion of the lamp body has a rough surface on which the fourth member of the second electrode is coated, the rough surface increasing adhesion between the second end portion of the lamp body and the fourth member of the second electrode.

39. The light assembly of claim 34, wherein the third member of the second electrode has a tube shape having opposite ends of which one is open and the other is closed.

40. The light assembly of claim 39, wherein a size of entire inner surface of the third member of the second electrode is substantially identical with a size of entire outer surface of the fourth member of the second electrode.

41. The light assembly of claim 27, wherein the second electrode includes:
a third member disposed in a second end portion of the lamp body, the third member receiving a driving voltage externally provided; and
a fourth member that receives the second end portion of the lamp body in which the third member is disposed, the fourth member having a contact part through which the third member is in contact with a electric source providing the driving voltage.

42. The light assembly of claim 41, wherein the third member of the second electrode includes:
an electrode body disposed in the discharge gas of the lamp body;
a lead wire that transfers the driving voltage to the electrode body; and
a sealing member that seals the second end portion of the lamp body to prevent a leak of the discharge gas and for holding the lead wire.

43. The light assembly of claim 42, wherein the sealing member has a conduit through which the lead wire is extended from the electrode body to the fourth member.

44. The lamp of claim 42, wherein the contact part of the fourth member of the second electrode is a hole through which the lead wire is extended to be in contact with the electric source.

45. An image display device for displaying images using light internally provided, comprising:
a display panel to display images using the light and image data externally provided;
a light assembly to provide the light, the light assembly comprising:
a lamp including:
a lamp body in which a discharge gas is injected; and
first and second electrodes disposed at opposite ends of the lamp body, the first and second electrodes receiving a driving voltage externally provided, wherein the first electrode includes:
a first member that receives a first end portion of the lamp body, the first member being electrically conductive; and
a second member disposed between the first member and the lamp body, the second member having metallic solder and being coated on the first end portion of the lamp body to provide adhesion between the first member and the lamp body;
a voltage applying module that receives the driving voltage from an external source and providing the driving voltage to the first and second electrodes of the lamp; and
a receiving container that receives and securely holds the lamp and the voltage applying module;
a first holding member disposed between the display panel and the light assembly, the first holding member securely holding the display panel onto the light assembly; and
a second holding member connected to the receiving container, the second holding member securely holding an edge of the display panel to prevent the display panel and the light assembly from being disassembled.

46. The image display device of claim 45, wherein the first member of the first electrode has a tube shape of which opposite ends are open to receive the first end portion of the lamp body.

47. The image display device of claim 45, wherein the first end portion of the lamp body has a rough surface on which the second member of the first electrode is coated, the rough surface increasing adhesion between the first end portion of the lamp body and the second member of the first electrode.

48. The image display device of claim 45, wherein the first member of the first electrode has a tube shape having opposite ends of which one is open and the other is closed.

49. The image display device of claim 45, wherein the second electrode of the lamp includes:
a third member that receives a second end portion of the lamp body, the third member being electrically conductive; and
a fourth member disposed between the third member and the lamp body, the fourth member having metallic solder and being coated on the second end portion of the lamp body to provide adhesion between the third member and the lamp body.

50. The image display device of claim 49, wherein the third member of the second electrode has a tube shape of which opposite ends are open to receive the first end portion of the lamp body.

51. The image display device of claim 49, wherein the second end portion of the lamp body has a rough surface on which the fourth member of the second electrode is coated, the rough surface increasing adhesion between the second end portion of the lamp body and the fourth member of the second electrode.

52. The image display device of claim 49, wherein the third member of the second electrode has a tube shape having opposite ends of which one is open and the other is closed.

53. The image display device of claim 45, wherein the second electrode includes:
a third member disposed in a second end portion of the lamp body, the third member receiving a driving voltage externally provided; and
a fourth member that receives the second end portion of the lamp body in which the third member is disposed, the fourth member having a contact part through which the third member is in contact with a electric source providing the driving voltage.

54. The image display device of claim 53, wherein the third member of the second electrode includes:
an electrode body disposed in the discharge gas of the lamp body;
a lead wire that transfers the driving voltage to the electrode body; and
a sealing member that seals the second end portion of the lamp body to prevent a leak of the discharge gas and for holding the lead wire, the sealing member having a conduit through which the lead wire is extended from the electrode body to the fourth member.

55. The image display device of claim 54, wherein the contact part of the fourth member of the second electrode is a hole through which the lead wire is extended to be in contact with the electric source.

56. A method for manufacturing a lamp, comprising:
forming a fluorescent layer on an inner surface of a lamp body;
inserting a discharge gas in the lamp body;
coating a first end portion of the lamp body with conductive material to form a first conductive layer on the first end portion, the conductive material having metallic solder; and
combining the lamp body with a first metal tube by inserting the first end portion into the first metal tube to form a first electrode of the lamp.

57. The method of claim 56, further including forming a first rough surface on the first end portion of the lamp body to increase adhesion between the first end portion and the first conductive layer coated on the first end portion.

58. The method of claim 56, wherein the conductive material has a melting point lower than the first metal tube.

59. The method of claim 58, wherein the metallic solder of the first conductive layer includes one of leadless metal mixed with tin and zinc, lead mixed with silver, lead, lead alloy, and a mixture thereof.

60. The method of claim 58, further including heating the first electrode to melt the conductive material so that the first conductive layer is uniformly filled with a uniform thickness between the first metal tube and the first end portion of the lamp body.

61. The method of claim 56, further including:
coating a second end portion of the lamp body with the conductive material to form a second conductive layer on the second end portion; and
combining the lamp body with a second metal tube by inserting the second end portion into the second metal tube to form a second electrode of the lamp.

62. The method of claim 61, further including forming a second rough surface on the second end portion of the lamp body to increase adhesion between the second end portion and the second conductive layer coated on the second end portion.

63. The method of claim 61, further including heating the second electrode to melt the conductive material so that the second conductive layer is uniformly filled with a uniform thickness between the second metal tube and the second end portion of the lamp body.
